(19) United States
(12) Patent Application Publication
(10) Pub. No.: US 2018/0208482 A1
(43) Pub. Date: Jul. 26, 2018

(54) ELUTION SYSTEMS FOR TREATMENT OF DISTRESSED WATERS

(71) Applicant: Phoenix Services, LLC, Kennett Square, PA (US)

(72) Inventor: Dennis G. Grubb, Lansdale, PA (US)

(21) Appl. No.: 15/745,170

(22) PCT Filed: Jul. 14, 2016
(86) PCT No.: PCT/US16/42249

§ 371 Date: Jan. 16, 2018

Related U.S. Application Data
(60) Provisional application No. 62/193,202, filed on Jul. 16, 2015.

(51) Int. Cl. C02F 1/28; C02F 1/00; E04D 13/08

(52) U.S. Cl. CPC C02F 1/281; C02F 2101/105; E04D 13/08; C02F 1/004

(57) ABSTRACT

Disclosed herein is an elution device comprising one or more inlets and one or more outlets and defining an interior volume comprising steel slag, wherein the elution device is mounted to a support and situated substantially above ground level. One or more inlets and one or more outlets are disposed to facilitate fluid flow from an inlet toward an outlet to cause contact of the eluant with the slag for a period sufficient to form an eluate. Also disclosed herein are methods of applying an eluant to the elution device and dispensing an eluate from an outlet proximal to a distressed water source to form a treated water source. Also disclosed herein are methods of applying an eluant to the elution device and dispensing an eluate from an outlet proximal to one or more areas having living plants thereon or therein.

### TECHNICAL FIELD

The invention relates generally to slag-based elution systems for water treatment.

### BACKGROUND

Slag is an industrial term of art for solid byproducts formed during a metal refining process, such as the smelting of various ores of copper, zinc, lead, etc. In the steelmaking processes, iron ore and/or scrap metal are melted in combination with calcium compounds; most commonly employed calcium compounds are limestone, dolomite, and lime. During steelmaking at temperatures above 1500° C., metal oxides are reduced and the added calcium reacts with and sequesters melt impurities (e.g., aluminum, silicon, and phosphorous ions) that are deleterious to the properties of the final steel product. The resulting waste material forms a separate phase (slag) that floats to the top of the melt where it is poured off for solidification and secondary uses.

Historically, slag banks and stockpiles are found in locations where steel is made or has been made over the past 170 years. Blast furnace (BF), basic oxygen furnace (BOF), and electric arc furnace (EAF) slags are currently processed for use primarily as aggregates in road construction, rail ballast, and structural fill. This involves crushing and grading the slag, and magnetically removing metallic fragments.

Since steel slag originates at temperatures in excess of 1500° C., materials having a lower boiling point, such as sulfur, selenium, carbon, cadmium, lead, copper, and mercury are substantially absent. Most of the residual materials in slag are oxides encased in a glassy calcium aluminosilicate matrix. Components within this matrix can be soluble and release calcium and manganese oxides when contacted with water, which drives the pH above 10. In its coarser form slag aggregates maintain high permeability (about 4.5×10⁻² cm/sec) to water.

Mayes, W. et al., Environ. Sci. Tech. 2006, 40, 1237-1243 note that steel slag leachate flow across natural wetlands can have a negative environmental impact. The leachates cause calcite precipitation that smothers aquatic habitats and reduces light penetration into the waters where the leachate was found to flow, and also causes the natural waters to have a high pH, which is purportedly harmful to fish populations. However, the waters into which the leachate was dispensed was not considered a distressed or polluted area. Further, subsequent studies have found that when steel slag is placed directly into fish tanks, brine shrimp and other species have a >95% survival rate in biotoxicity studies. Similar results would be expected for e.g. oyster beds and other sensitive surface water environments.

However, in some cases steel slag is employed in a reactive filter to sequester certain harmful materials from waste water. Thus, for example, Hilton Jr. et al., U.S. Pat. No. 6,893,570 disclose in-ground pond-type structures loaded with steel slag to capture mine drainage wastes, wherein the slag reacts with the drainage waste to produce manganese species that precipitate and can be recovered. The pond is situated at an elevation wherein manganese-bearing waste water can flow into the pond. The manganese is precipitated by the alkalinity that results from contact of the manganese-bearing water with the slag in the pond; the precipitate is separated from the water in the pond by settling, and the purified water is discharged. Permeability reductions of the slag can be problematic due to the precipitate formation; thus, coarse sized slag material is preferentially employed, wherein individual pieces are optimally about 1 to 6 inches in diameter. A mechanism for removing the resulting manganese-bearing precipitates from the pond is also disclosed.

Others have proposed the use of steel slag for removal of phosphorus waste from runoff water, as a means to prevent high concentrations of phosphorus species from reaching surface waters. Municipal wastewater drainages are significant sources of phosphorus loads into surface water such as rivers, lakes, or lagoons. It is well known that these phosphorus loads can promote abnormal growths of algae and aquatic plants in surface waters, resulting in degradation of water quality and leading to eutrophication.

Thus, for example, Drizo et al., Environ. Sci. Technol. 2002, 36, 4642-4648; Pratt et al., Environ. Sci. Technol. 2007, 41, 6585-6590; Drizo et al., Environ. Sci. Technol. 2008, 42, 6191-6197; Bowden et al., Environ. Sci. Technol. 2009, 43, 2476-2481; Eveborn et al., Environ. Sci. Technol. 2009, 43, 6515-6521; Claveau-Mallet et al., Environ. Sci. Technol. 2012, 46, 1465-1470; Barca et al., Environ. Sci. Technol. 2013, 47, 549-556; Claveau-Mallet et al., Environ. Sci. Technol. 2014, 48, 7486-7493; Grubb et al., J. Hazard. Toxic Radioact. Waste 2014.18; Blowes et al., U.S. Pat. No. 5,876,606; Phifer et al., U.S. Pat. No. 6,254,785; Smith, U.S. Pat. No. 6,602,421, Drizo et al., U.S. Patent Pubs. 2008/0078720 and 2013/0032544 and U.S. Pat. No. 8,721,885; and others have proposed, optimized, or studied passive or active immobilization of waterborne phosphates by applying the phosphate-containing water source to a filtration media and/or device packed with particulate steel slag. As the phosphate-containing water is passed through the filtration device, the phosphorus is precipitated and retained within the filtration device, and the resulting purified water is allowed to pass through. The filtration devices are situated in the path of polluted water that is passively or actively applied and filtered therein.

Such filter devices must be cleaned or replaced periodically due to the buildup of precipitates and the consequent loss of system permeability or chemical reactivity. Studies conducted by some of the above-listed authors have addressed this issue by investigating: 1) the rates of permeability loss in the slag-based filter devices due to accumulation of precipitates; 2) the rates of precipitation of phosphorus phases within the slag; and/or 3) regeneration of slag-based filtration systems to overcome the loss of permeability in these systems over time and/or after exposure to large concentrations of phosphorus species in the water contacting the filter devices. It is the characteristic nature of sites such as fertilized farms, golf courses, dairies, stock yards that the most severe impacts of phosphates and other contaminants occur during or soon after rainfall events owing to the resulting surface water runoff into sloughs, streams, rivers, lakes, or other surface water sources. Often, engineered treatment systems to accommodate these flows require them to be oversized despite their merely periodic use, in order to accommodate larger volume requirements when they arise.

Ziemkiewicz, Proceedings of the 1998 Conference on Hazardous Waste Research, May 18-21, 1998, Snowbird, Utah; p. 44-62 (available for download at https://www.engg.ksu.edu/HSRC/98Proceed/5Ziemkiewicz/5ziemkiewicz.pdf) discloses the use of steel slag in treating acid mine drainage by employing steel slag loaded ponds within the ground, wherein the ponds are situated at elevations above known sources of acidic mine drainage sources. Water added to the bed becomes alkaline, and the alkaline water flows downhill toward or along with the acidic mine drainage to act as a pH neutralizing agent. The Ziemkiewicz pond is shown in FIG. 1. The technology relies on existence of a geographical location situated uphill from the mine drainage flow, further wherein the location is suitable for a pond, further wherein the flow pattern away from the pond will proceed in a direction suitable to combine the flow with the acid mine drainage. The technology is therefore not suitable for use in some geographic locations in need of treatment, such as in urban or suburban areas. Further, the pond installation is effectively permanent, since it is an engineered structure formed within the ground itself.

There is a need in the industry to remediate phosphate contaminants or other undesirable chemical species from distressed water sources. There is a need to remediate such sites using easily implemented technology. There is a need in the industry to provide passive systems for delivery of remediation materials to groundwater and surface water. There is a need in the industry to provide such systems that can be implemented in an unlimited number of geographic locations. There is a need for a passive system that is operable during periods of rainfall, when water sources proximal to phosphate contaminants or other undesirable chemical species are most impacted by runoff. There is a need in the industry to provide systems for delivery of remediation materials using an easily transported remediation system. There is a need in the industry to provide systems for delivery of remediation materials wherein the system can be situated for ease of inspection, replenishment, and/or replacement. There is a need in the industry to provide systems for delivery of remediation materials wherein the systems are transportable or mobile.

### SUMMARY

Disclosed herein is an elution system comprising a support and an elution device mounted to the support such that the device is situated substantially above ground level, the elution device defining an inlet, an outlet, and an interior volume, the interior volume comprising steel slag, wherein an eluant applied to the inlet flows into the interior volume and toward the outlet, wherein said flow causes contact of the eluant with the slag. In some embodiments, the support is a building. In some such embodiments, the inlet is in fluid communication with a rain gutter, a rooftop drain, a source of tap water, a source of surface water, or a combination of two or more thereof. In some embodiments, the eluant is substantially free of compounds or ions that react with components of the steel slag. In some embodiments, the slag is characterized as having an average particle size of about 100 μm to 15 cm. In some embodiments, the elution device is substantially filled with slag. In some embodiments, the elution system further comprises one or more filtration means situated proximal to the inlet, the outlet, or both. In some embodiments, the elution system further comprises an eluant conduit in fluid communication with the inlet. In some embodiments, the elution system further comprises an eluate conduit in fluid communication with the outlet. In some embodiments, the device comprises two or more inlets, two or more outlets, or both.

Also disclosed herein is a method for treating a distressed water source, the method comprising operably mounting an elution device to a support, the elution device defining an inlet, an outlet, and an interior volume, the interior volume comprising steel slag; applying an eluant to the inlet, wherein the applied eluant flows into the interior volume and into contact with the slag for a period of time sufficient to form an eluate; and dispensing the eluate from the outlet proximal to a distressed water source, wherein contact of the eluate with the distressed water source causes formation of a treated water source. In some embodiments, the mounting is removably mounting. In some embodiments, the method further comprises one or more of the following: dissassembling the elution system; disassembling the elution device; transporting the elution device; reassembling the elution system; reassembling the elution device; carrying out one or more disassembly/reassembly cycles of the elution device; and carrying out one or more disassembly/reassembly cycles of the elution system. In some embodiments, the eluant has a first pH and the eluate has a second pH, wherein the first pH is about −1 to 8 and the second pH is about 9 to 13. In some embodiments, the eluant comprises one or more of distilled water, deionized water, rain water, tap water, a treated water source, surface water, or groundwater. In some embodiments, the period of time is about 10 seconds to 10 days. In some embodiments, the eluate comprises about 1 mM to 1000 mM calcium hydroxide. In some embodiments, the distressed water comprises a phosphate compound. In some embodiments, the contact causes one or more phosphate compounds to form a precipitate comprising calcium and phosphorus.

Additional advantages and novel features of the invention will be set forth in part in the description that follows, and in part will become apparent to those skilled in the art upon examination of the following, or may be learned through routine experimentation upon practice of the invention.

### BRIEF DESCRIPTION OF THE DRAWINGS

FIG. 1 is a diagram of a steel slag loaded pond configuration, as disclosed in Ziemkiewicz, Proceedings of the 1998 Conference on Hazardous Waste Research, May 18-21, 1998, Snowbird, Utah; p. 44-62.

FIG. 2A is a three-dimensional illustration of an elution device in an elution system of the invention.

FIG. 2B is an illustration of a portion of the elution device of FIG. 2A, showing the relative positions of certain features of the device.

FIG. 3 is a three-dimensional illustration of an elution device in another elution system of the invention.

FIG. 4A is a three-dimensional illustration of an elution device in another elution system of the invention.

FIG. 4B is a side view schematic illustration of the elution device of FIG. 4A.

FIG. 5 is a side view illustration of an elution device in another elution system of the invention.

FIG. 6 is a schematic illustration of an elution device in another elution system of the invention.

FIG. 7 is a side view illustration of an elution device in another elution system of the invention.

FIG. 8 is a three-dimensional illustration of an elution device in another elution system of the invention.

FIG. 9 is a schematic illustration of an elution system of the invention.

FIG. 10 is a schematic illustration of another elution system of the invention.

FIG. 11 is a schematic illustration of another elution system of the invention.

FIG. 12 is a schematic illustration of a water treatment loop including an elution system of the invention.

FIG. 13 is a plot showing PO₄ concentration as a function of initial PO₄ concentration, volumetric mixing ratio, and slag type.

FIG. 14 is a plot showing the same data as FIG. 13, corrected for rate of PO₄ dilution.

FIG. 15A is a plot showing calcium concentration of a slag eluate as a function of eluant pH.

FIG. 15B is a plot showing magnesium concentration of a slag eluate as a function of eluant pH.

FIG. 15C is a plot showing silicon concentration of a slag eluate as a function of eluant pH.

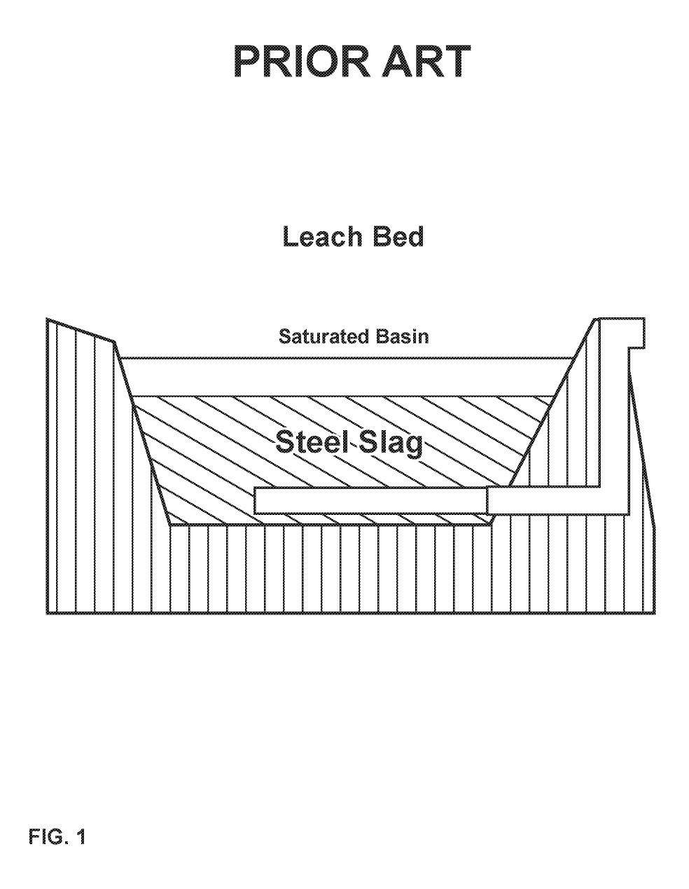

### DETAILED DESCRIPTION

Although the present disclosure provides references to preferred embodiments, persons skilled in the art will recognize that changes may be made in form and detail without departing from the spirit and scope of the invention. Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

We report herein systems and methods to dispense a steel slag eluate onto the surface of the earth or into a body of water. The dispensed eluate is contacted with a distressed water source to convert the distressed water source to a treated water source. The elution systems are designed and adapted to receive an eluant, contact the eluant with steel slag for a period of time sufficient to form an eluate, and dispense the eluate onto the surface of the earth or into a body of water proximal to or in contact with a distressed water source. The systems do not retain a substantial amount of materials removed from the eluate. Thus, the systems are not filtration systems.

The systems and methods are operable independent of geographical features proximal to or in contact with distressed water sources. The systems include an elution device including steel slag, wherein the elution device is disposed substantially above ground level. Thus, replenishment or replacement of the steel slag is easily carried out, and inspection of the system, and the slag contained therein, is easily conducted. The systems do not require excavation and do not require construction of a pond, trench, filtration device, or other mechanism or device that extends below ground level. In some embodiments, dispensing of the eluate is accomplished employing gravitational force. In some embodiments, the systems are substantially passive, that is, the systems require substantially no external sources of energy to operate.

Described herein is an elution system comprising, consisting essentially of, or consisting of an elution device operably mounted on a support, the elution device comprising one or more inlets and one or more outlets and defining an interior volume comprising steel slag, wherein the elution device is situated substantially above ground level and further wherein one or more inlets and one or more outlets are disposed to facilitate fluid flow from an inlet to an outlet by gravitational force, and further wherein said fluid flow causes contact of the eluant with the slag. The eluant enters the elution device and dissolves compounds present in the slag during the contact therewith to become an eluate. The eluate is dispensed from an outlet toward the surface of the earth, below the surface of the earth, and/or into a body of water. In some embodiments, the elution device comprises two or more inlets for one or more eluants. In some embodiments, the elution device comprises two or more outlets to dispense one or more eluates.

In some embodiments, the elution device, support, or both include one or more attachment means to operably mount the elution device to the support. In some embodiments, the elution device, support, or both include one or more attachment means to operably and removably mount the elution device to the support.

In some embodiments, the elution system is designed and adapted to passively receive an eluant, wherein gravitational force urges the eluant through an inlet, into contact with the steel slag within the elution device interior volume to form an eluate, wherein the eluate is dispensed through an outlet. In some embodiments, one or more inlets are fluidly connected to a rain water collector such as a gutter or rooftop drain, such that rain water is passively collected and directed toward and through one or more inlets. In some embodiments, an eluant conduit is disposed between and in fluid connection with the collector and/or one or more inlets. In some embodiments, one or more outlets are fluidly connected to an eluate conduit designed and adapted to receive an eluate from the elution device and direct the eluate to a selected location for dispensing onto the surface of the earth, below the surface of the earth, or into a body of water.

Also described herein is a method for treating distressed water, the method comprising mounting an elution system to a support, the elution system comprising an elution device comprising an inlet and an outlet and defining an interior volume comprising steel slag, wherein the mounting comprises attaching the elution system to the support to dispose the elution device substantially above ground level and wherein the inlet and outlet are disposed to facilitate fluid flow through the inlet, into the interior volume where it contacts the steel slag, and toward the outlet by gravitational force; applying an eluant to the inlet, the eluant having a first pH; contacting the steel slag with an eluant to form an eluate, the eluate having a second pH that is greater than the first pH; dispensing the eluate from the outlet toward the surface of the earth proximal to the distressed water. Contacting the distressed water with the eluate causes the distressed water to form treated water.

### Definitions

As used herein, the term “steel slag” or “slag” means any alumina-siliceous byproduct of an iron making or steelmaking process wherein iron ore, scrap metal, and/or alloys are melted in combination with one or more calcium-rich compounds or materials. The term “steel slag” or “slag” further includes blends of slags obtained from two or more slag sources. The term “steel slag” or “slag” further includes blends of two or more average particle size slags.

As used herein, the term “eluant” means a source of liquid water that is not adistressed water. In some embodiments, the eluant is substantially free of compounds that may precipitate, or may be otherwise immobilized when contacted with components of the steel slag or an eluate thereof. In some embodiments, the eluant contacting the slag is substantially free of solids that can be filtered by the steel slag within the interior volume of the elution device.

As used herein, the term “eluate” means eluant that has contacted steel slag inside the elution device for a sufficient period of time to provide at least 1 mM calcium as CaO or Ca(OH)₂ dissolved therein. The eluate comprises, consists essentially of, or consists of the eluant and one or more solutes derived from contact with the slag.

As used herein, the term “solute” means one or more materials, species, compounds, ions, or mixtures thereof derived from steel slag and comprising CaO and/or Ca(OH)₂.

As used herein, the term “contaminant” means a material, species, compound, or ion that is dissolved or dispersed in a water source as a result of human activity, further where the compound or ion is capable of precipitating, co-precipitating, or sorbing onto other solids phase materials when contacted with an eluate. Contaminants include, but are not limited to, phosphorus species including orthophosphates, polyphosphates, and metaphosphates.

As used herein, the term “distressed water” or “distressed water source” means a water source comprising one or more contaminants dissolved or dispersed therein. Water sources include groundwaters, surface waters, process waters, and aqueous runoff from industrial or agricultural processes.

As used herein, the term “treated water” means a distressed water contacted with an eluate, wherein the treated water is characterized by a reduced concentration of one or more contaminants when compared to the initial concentration of the one or more contaminants in the distressed water.

As used herein and as it pertains to the elution systems of the invention, the term “substantially above ground level” means that the elution device is situated such that one or more outlets of the elution device contacts the surface of the earth or is situated above the surface of the earth.

As used herein as it pertains to the elution systems of the invention, the term “mounted” or “operably mounted” means an elution system is arranged such that the elution device is situated substantially above ground level, further wherein gravity (hydraulic head) causes an eluant applied to an inlet of an elution device to flow through an inlet, into the interior volume of the device, and toward an outlet, said flow further causing the eluant to contact the steel slag.

Reference to the elution device being situated substantially above ground level further or alternatively refers to the elution device adapted to be so situated, unless limited by context. Reference to an elution system being operably mounted further or alternatively refers to the elution system adapted to be operably mounted, unless limited by context.

As used herein as it pertains to the elution systems of the invention, the term “support” means any structure, feature, or portion thereof capable of having an elution device operably mounted thereon.

As used herein as it pertains to the elution devices, supports, and systems of the invention, “attachment means” means one or more clips, latches, brackets, screws, nails, snaps, buttons, ties, clamps, straps, adhesive compositions, hook and loop or other mating fasteners, combinations of these, and similar items as well as adjunct equipment including braces, extension bars, brackets, handles, quick-release mechanisms, and the like as will be familiar to those of skill. In some embodiments, attachment means comprises, consists essentially of, or consists of gravity.

As used herein as it pertains to the elution devices and systems of the invention, “filtration means” means one or more means for retaining macroscopic or particulate matter while allowing a fluid to pass. Suitable filtration means include screens, mesh, nonwoven thermoplastic or glass mats, frits, porous membranes, perforated plates or films, woven fabrics, filter paper, felted fabrics, and like materials as well as associated housings or other infrastructure intended to operably dispose the filtration means within an elution system.

As used herein, the terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “optional” or “optionally” means that the subsequently described event or circumstance may but need not occur, and that the description includes instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” the recitation means “1 to 5”, “about 1 to about 5”, “1 to about 5” and “about 1 to 5” unless specifically limited by context.

As used herein, the word “substantially” modifying, for example, the type or quantity of an ingredient in a composition, a property, a measurable quantity, a method, a position, a value, or a range, employed in describing the embodiments of the disclosure, refers to a variation that does not affect the overall recited composition, property, quantity, method, position, value, or range thereof in a manner that negates an intended composition, property, quantity, method, position, value, or range. Examples of intended properties include, solely by way of non-limiting examples thereof, flexibility, partition coefficient, rate, solubility, temperature, and the like; intended values include thickness, yield, weight, concentration, and the like. The effect on methods that are modified by “substantially” include the effects caused by variations in type or amount of materials used in a process, variability in machine settings, the effects of ambient conditions on a process, and the like wherein the manner or degree of the effect does not negate one or more intended properties or results; and like proximate considerations. Where modified by the term “substantially” the claims appended hereto include equivalents to these types and amounts of materials.

Elution Systems

In embodiments, an elution system of the invention comprises an elution device operably mounted to a support. The elution device comprises at least one inlet and at least one outlet. The elution device defines an interior volume, wherein the interior volume comprises steel slag. The elution device is configured and mounted substantially above ground level. The elution device is designed and adapted to receive a fluid flow through an inlet, into the interior volume thereof, and toward an outlet, further wherein the fluid contacts the steel slag. The fluid flow is dispensed from the outlet onto the surface of the earth, below the surface of the earth, or into a body of water. The fluid flow received by the inlet is an eluant. The fluid flow dispensed from the outlet is an eluate. Eluate is formed within the elution device by contacting the eluant with the steel slag for a sufficient amount of time to dissolve one or more solutes therein, wherein the solutes are derived from the steel slag.

Steel slags useful in the elution devices of the invention are the alumina-siliceous byproducts of iron making or steelmaking processes wherein iron ore, scrap metal, and/or alloys are melted in combination with one or more calcium-rich compounds or materials. Examples of suitable steel slag sources include but are not limited to blast furnace (BF) slags, basic oxygen furnace (BOF) slags, electric arc furnace (EAF) slags, and related ladle slags. Examples of suitable calcium-rich compounds and materials include but are not limited to limestone, dolomite, and lime.

In some embodiments, a steel slag is a blend of slags obtained from two or more slag sources. In some such embodiments, the two or more slag sources differ in terms of chemical composition, average particle size, or both. In some embodiments, a steel slag is a blend of slags having two or more average particle sizes. In some embodiments, a steel slag is a blend of slags obtained from two or more sources such as BF, BOF, EAF, or ladle sources. It is an advantage of the methods and articles of the invention that any blend of slags from various slag sources are easily employed within the elution devices and elution systems of the invention.

Steel slags particularly useful in the elution devices are substantially particulate materials as formed or as provided by one or more comminution processes. Steel slag sources are not limited in terms of particle size. In some embodiments, a steel slag is a blend of two or more average particle size slags. In embodiments a slag is a particulate having an average particle size, or a maximum particle size or particle size range as determined by methods such as sieving, of about 100 μm to 15 cm, for example about 500 μm to 15 cm, or about 1 mm to 15 cm, or about 2 mm to 15 cm, or about 3 mm to 15 cm, or about 100 μm to 10 cm, or about 100 μm to 8 cm, or about 100 μm to 6 cm, or about 100 μm to 4 cm, or about 100 μm to 2 cm, or about 100 μm to 1 cm, or about 100 μm to 8 mm, or about 100 μm to 6 mm, or about 100 μm to 4 mm, or about 1 mm to 1 cm, or about 1 mm to 6 mm. The steel slag source and particle size is selected by one of skill to meet the particular needs of the user and any requirements of the particular elution device design. Such particular needs and requirements include, for example, particle size availability; availability of comminution equipment, expected rate of fluid flow into, within, or out of the elution device, conductivity or permeability of the slag particles, reactivity of the slag, and the like.

The elution device is formed from any material suitable for holding steel slag particulates, eluant, and the eluate formed from contacting the eluant with the steel slag inside the elution device. Suitable examples of materials useful in forming the elution devices include stainless steel, aluminum, glass or ceramic, thermoplastic or thermoset polymers that are not reactive with the eluant, eluate, or steel slag; such polymers include those based on polyolefins such as polypropylene, polyethylene, and the like. In some embodiments the elution device includes two or more materials; for example, in an exemplary embodiment, the elution device includes a metal outer shell and an interior liner formed from an unreactive thermoplastic such as polyethylene or another material that is substantially unreactive and is not dissolved in the presence of an eluant or eluate.

The elution device defines an inner volume. The inner volume includes steel slag. In some embodiments, the entire volume of the elution device is filled with slag. In other embodiments, a portion of the volume is filled with slag. In some embodiments, the interior volume includes additional features such as prefilters to filter the eluant prior to the eluant contacting the slag; one or more weirs, static mixing elements, interior walls, valves, baffles, or the like to control fluid mixing and flow inside the elution device; one or more filtration means; and the like. In some embodiments, the interior volume further includes one or more additional materials. The one or more additional materials include solid materials for adding one or more additional solutes to an eluate, or for removing one or more compounds from an eluant; or for providing a mixture of the slag with an inert material within the elution device.

The elution device size is not particularly limited and is selected by the skilled artisan to comport with the wishes of the owner of the support, the size of the support, the volume of eluant to be applied to the elution device, and the amount of eluate needed to treat a distressed water proximal to the elution device. The elution device shape is not particularly limited and is selected by the skilled artisan for convenience, to fit in an intended fashion with or to the support to which it is or will be attached, for aesthetic style, or for attaching or providing one or more additional features or functionalities to the elution device; or two or more thereof. In some embodiments, the elution device has an overall cuboid shape, that is, a cubic or a rectangular parallelepiped shape. In some embodiments, the elution device has an overall cylindrical shape, or a funnel type shape, or a combination of a cylindrical shape with a funnel shape portion. Since the elution device is disposed substantially above ground level, it may be generally visible and so decorative shape or other decorative or camouflaging features are employed in some embodiments associated with the elution device, the elution system, or portions thereof.

The elution device includes one or more inlets adapted to receive an eluant applied thereto. The elution device further includes one or more outlets adapted to dispense an eluate from the elution device. When the elution device is operably mounted to a support, an eluant applied to an inlet of the elution device flows fluidly toward an outlet by force of gravity, further wherein said flow causes the eluant to contact the steel slag and form an eluate. Gravity causes the applied eluant to flow into the elution device inner volume and into contact with the steel slag. In some embodiments, the elution device includes a top portion and one or more inlets are situated on the top portion. The one or more inlets are not limited by dimension and are selected by the skilled artisan to comport with the volume of water to be applied to the inlet, the size of the defined interior volume of the elution device, and/or the volume of water to be eluted either overall or per unit of time.

In some embodiments, the elution device comprises a top portion comprising an inlet and a bottom portion comprising an outlet. In some embodiments, the top portion comprises a single inlet. In some such embodiments, the single inlet comprises the entirety of the top portion of the elution device. In some embodiments, one or more filtration means are situated proximal to, extending across a portion of, or extending substantially across the entirety of an inlet for the purpose of retaining macroscopic debris, such as organic matter, or particulates while allowing the eluant to enter the interior volume of the device and contact the slag.

In some embodiments, the elution device is designed and adapted to maintain a substantially closed system surrounding the slag. It is known that wet slag adsorbs carbon dioxide (CO₂) from the air over time, forming calcium carbonate (CaCO₃). By slowing or excluding ingress of some CO₂ into the device, the system provides alkalinity as CaO species over a longer period of time before replenishment or replacement of slag is needed. This effect is suitably maximized in embodiments where, for example, the device is substantially packed with slag, or a mixture thereof with another material, thereby excluding extraneous air from the device. In some embodiments, one or more valves, shutters, doors, caps, or other means of substantially closing off one or more inlets and/or one or more outlets of the elution device further provide additional extension of the slag's operational lifetime by preventing conversion of some calcium species within the slag to CaCO₃. Optionally, an inlet, outlet, or both further comprise a spring-activated flap that acts as a check valve to exclude a portion of air from contacting the contents of the elution device during periods of time when eluant is not being applied to an inlet.

Optionally, one or more eluant conduits are in fluid communication with one or more inlets. Suitable eluant conduits include pipes, hoses, funnels, or tubes formed from one or more materials such as glass, metal, or plastic. In some embodiments the conduits are flexible to allow placement by the user, thus enabling the user to easily position the conduit and adjust the flow path leading to an inlet. In some embodiments a conduit is fluidly connected to an inlet. In some embodiments a conduit is fluidly connected to a source of eluant. In some such embodiments, the eluant source is a rain gutter or rooftop drain and the eluant is rain water. In some embodiments a conduit is fluidly connected to an inlet and to a source of eluant.

The elution device further includes at least one outlet. In some embodiments, the elution device includes a bottom portion and one or more outlets are disposed on the bottom portion of the elution device. The location of the one or more outlets is not particularly limited, but in general an outlet is disposed to dispense an eluate by force of gravity when the elution device is operably mounted on a support. The dimensions of the outlets are not particularly limited. In some embodiments the dimensions of the one or more outlets are selected to be similar to the dimensions of one or more inlets. In some embodiments, one or more filtration means are situated proximal to, extending across a portion of, or extending substantially across the entirety of an outlet for the purpose of retaining slag within the device while dispensing the eluate.

Optionally, one or more eluate conduits are disposed in fluid communication with one or more outlets. The eluate conduits lead away from the one or more outlets and extend generally toward or upon the surface of the earth. In some embodiments a conduit is fluidly connected to an outlet. Suitable eluate conduits include pipes, hoses, funnels, or tubes formed from one or more materials such as metal or plastic that do not react with or degrade in the presence of the eluate. In some embodiments the conduits are flexible to allow placement by the user, thus enabling the user to fine-tune the direction of eluate dispensing. In some embodiments, the eluate conduit is employed to dispense the eluate into a container, where it is stored for future use or metered dispensing. In other embodiments, the eluate conduit is employed to dispense the eluate directly onto the surface of the earth, beneath the surface of the earth, or into a body of water proximal to one or more sources of distressed water.

In some embodiments, the elution systems include one or more filtration means. In some embodiments, filtration means are means for removing particulates, macroscopic debris, or both from an eluant prior to the eluant contacting the slag. In some embodiments, filtration means are means for retaining slag within the interior volume of an elution device while allowing an eluate to be dispensed from an outlet. In some embodiments the filtration means is situated proximal to an inlet of an elution device, and is adapted and designed to retain macroscopic debris such as organic matter, particulates, or both from an eluant while allowing the eluant to flow through the inlet, into the interior volume of the device, and to contact the slag. In some embodiments a filtration means is situated proximal to an outlet of an elution device, and is adapted and designed to retain the slag within the interior volume of the device while allowing an eluate to be dispensed from the outlet. Suitable filtration means are selected by the user depending on the positioning, rate of eluant/eluate flow, expected or known size of the filtrate, inlet/outlet dimensions, and similar considerations. Suitable filtration means include screens, mesh, nonwoven thermoplastic or glass mats, frits, porous membranes, perforated plates, woven fabrics, filter paper, felted fabrics, and the like materials.

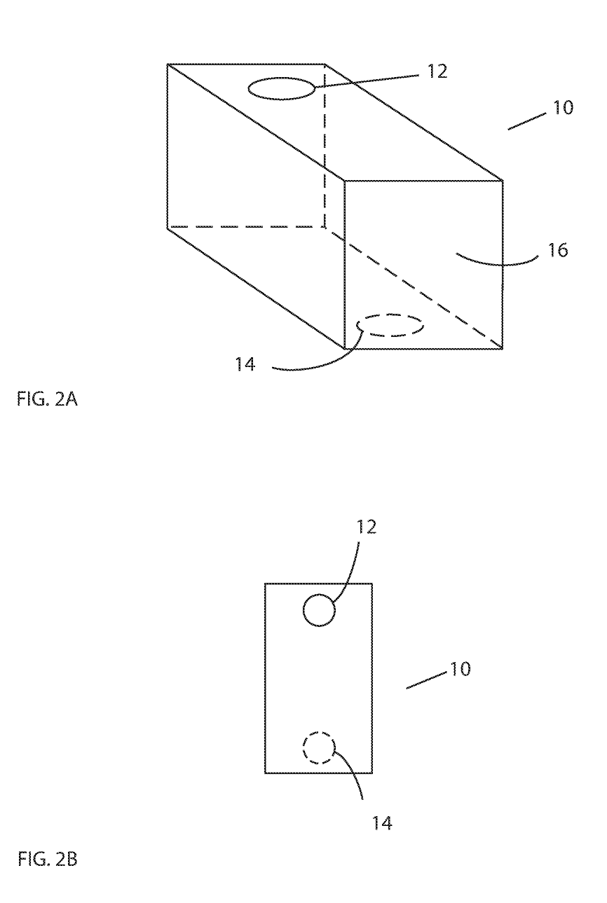

Some exemplary elution devices are shown in FIGS. 2-7. It will be understood by those of skill that many other device designs may be employed in addition to those shown. In referring to the Figures, elution devices 10 include inlet 12, outlet 14, and defined interior volume 16 which is at least partially filled with slag, and unless otherwise indicated can be partially filled or substantially filled with slag, as selected by a user; in some embodiments the volume 16 is partially filled with a material other than slag such as sand or a reactive material for adsorbing or releasing one or more components as is described in more detail below. In further referring to the Figures, arrows labeled A show general direction of eluant flow during use of an elution system, arrows B show direction of flow within the interior volume 16 of an elution device 10 during use of an elution system, and arrows C show general direction of eluate flow during use of an elution system. Thus, an eluant applied to an elution device 10 via an inlet 12 follows a flow path, where indicated, of A to B to C.

FIG. 2A shows that eluant applied to inlet 12 of device 10 will flow into interior volume 16 and can contact slag disposed therein before flowing through outlet 14. FIG. 2B is a top view of the device of FIG. 2A, showing the relative positions of inlet 12 and outlet 14. In some embodiments, device 10 includes one or more flaps or valves to reversibly close one or both of inlet 12 and outlet 14 such that the one or more flaps or valves are substantially closed in the absence of eluant, and are urged toward an open position when contacted with eluant flow toward inlet 12 or an eluate flow toward outlet 14.

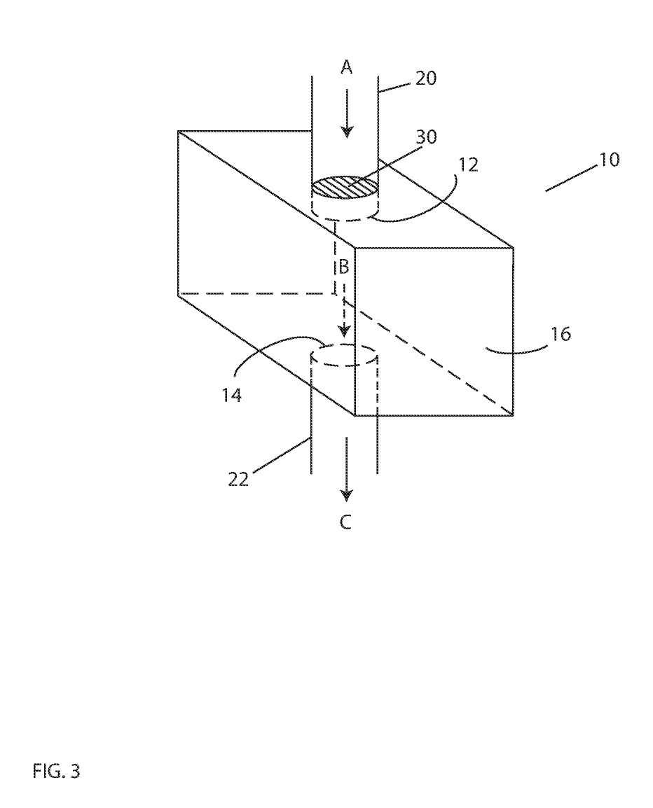

FIG. 3 shows eluant conduit 20 fluidly attached to inlet 12 and eluate conduit 22 fluidly attached to outlet 14. Disposed within eluant conduit 20 proximal to inlet 12 is filtration means 30. Filtration means 30 is a cartridge-type filter. Filtration means 30 includes, in various embodiments, means suitable for excluding macroscopic matter such as leaves, twigs, and large soil particulates, human-generated waste debris such as paper or plastic items or parts thereof, and the like, or microscopic particulates dispersed within the eluant. More than one such filter media directed at one or more macroscopic or microscopic materials are suitably included within filtration means 30. Additionally, in some embodiments filtration means 30 includes instead of or in addition to filter media, one or more reactive materials. Reactive materials produce, react with, or sequester one or more impurities from an eluant, release one or more compounds into the eluant, or cause a chemical transformation of an eluant component. For example, carbon black or porous carbon particulates, zeolites, ion exchange resins, encapsulated reagents, flocculants, or other materials suitable for adjusting the chemical content of the eluant is suitably included within filtration means 30 as a discrete region or layer or dispersed within the filtration means.

In some embodiments, one or more materials in addition to the slag are provided within the interior volume 16 of elution device 10, for example mixed with the slag within the interior volume 16 or present as a substantially discrete layer therein. Where the interior volume 16 includes a blend of slag and one or more additional materials, the interior volume 16 is said to include a slag-based material. In some such embodiments, the slag-based material includes a substantially inert particulate. Suitable inert materials include thermoplastic, metal, or ceramic particulates, fibers, beads, bubbles, and the like. Such inert materials substantially unreactive toward the eluant and are suitably blended with slag within the interior volume 16 of elution device 10 to promote a selected elution rate, for example, by increasing porosity of the slag based media. In other embodiments, the slag-based material includes one or more reactive materials, such as carbon black or porous carbon particulates, zeolites, ion exchange resins, encapsulated reagents, flocculants, or other materials suitable for adjusting the chemical content of the eluate.

In some embodiments, filtration means 30 is one or more of the following: removable, replaceable, replenishable, disposable, or self-cleaning. In some embodiments, filtration means 30 is a cartridge-type filter. Filtration means 30 optionally further includes one or more additional materials necessary to form a filter element suitable for disposition, such as housings and attachment means including removable attachment means to secure the filtration means within an elution system.

Filtration means 30 is a representative embodiment of a filtration means as described elsewhere herein. In particular filtration means 30 is representative of eluant filtration means present proximal to an inlet of an elution device. In some embodiments, the eluant filtration means is disposed proximal to an inlet and within the interior volume of an elution device. In some embodiments, eluant filtration means is disposed within a conduit fluidly attached to an inlet of an elution device; in some such embodiments the filtration means is proximal to an inlet; in other embodiments filtration means is located elsewhere within the fluid flow path leading to an inlet of an elution device. In some embodiments, eluant filtration means is disposed substantially co-continuously with an inlet of an elution device.

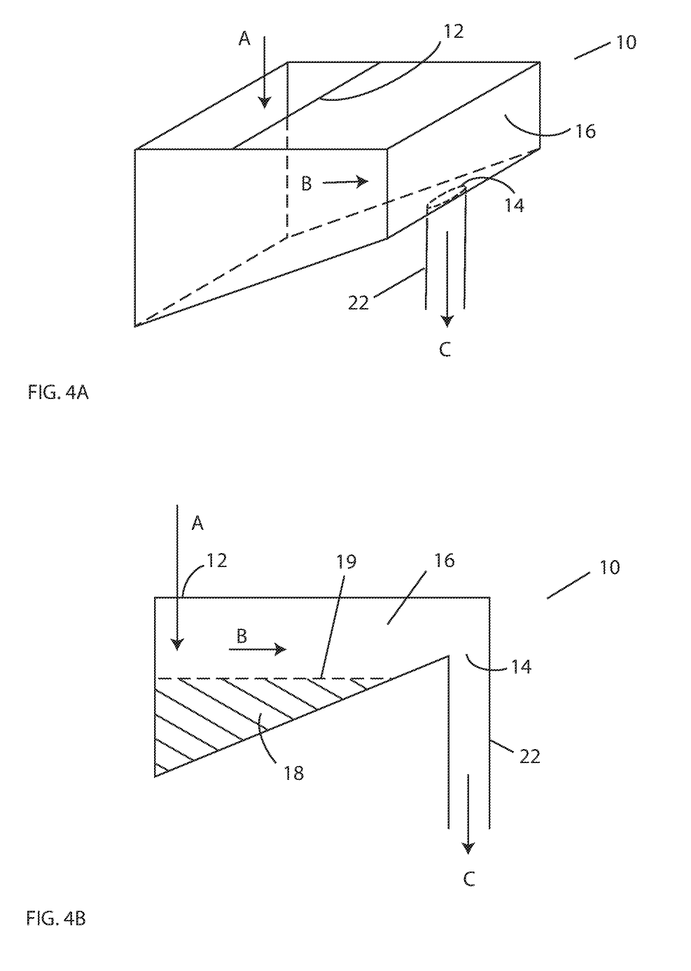

FIG. 4A shows an elution device 10 having a square frustum-like shape. FIG. 4B is a side view of the elution device of FIG. 4A, further wherein dashed line 19 denotes the level of slag fill 18 inside the elution device. The utility of the frustum-like shape is seen in FIG. 4B, wherein eluant applied to inlet 12 of elution device 10 contacts slag 18; eluant continues to accumulate from inlet 12 until the level of liquid in elution device 10 reaches outlet 14. Since the level 19 of slag 18 is lower than the level of outlet 14, slag 18 is retained within inner volume 16 while eluate exits outlet 14 and proceeds through eluate conduit 22.

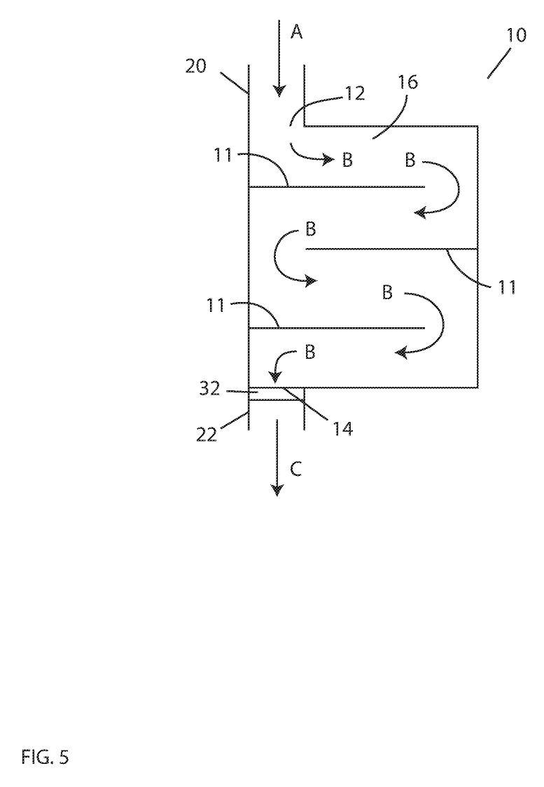

FIG. 5 shows elution device 10 having interior walls or baffles 11. Walls or baffles 11 are designed and disposed to create a flow path, shown by arrows B. In some such embodiments, elution device 10 is substantially filled with slag or a slag mixture between inlet 12 and outlet 14. Eluant applied to inlet 12 through eluant conduit 20 flows into elution device 10, where it contacts slag as it follows flow path B before exiting outlet 14 and proceeding through eluate conduit 22. Filtration means 32 is disposed substantially co-continuously with outlet 14. Filtration means 32 includes, in various embodiments, means suitable for excluding slag from exiting outlet 14 while allowing an eluate to traverse outlet 14 along the path indicated by arrows B to C. Additionally, in some embodiments filtration means 32 includes instead of or in addition to filtration articles similar to filtration means 30 of FIG. 3, one or more materials for reacting with or sequestering one or more solutes from an eluate or for adding one or more additional solutes to an eluate. Such materials are present as a discrete region or layer, or are dispersed within the filtration means 32. In some embodiments, filtration means 32 is one or more of the following: removable, replaceable, replenishable, disposable, or self-cleaning. In some embodiments, filtration means 32 is a cartridge-type filter. Filtration means 32 optionally further includes one or more additional materials necessary to form a filter element suitable for disposition, such as housings and attachment means including removable attachment means to secure the filtration means 32 within elution device 10. In some embodiments, filtration means 32 is characterized as a high strength filtration means, wherein the filtration means 32 further provides means and properties suitable to hold the weight of the slag substantially within interior volume 16 as against gravitational force.

Filtration means 32 is a representative embodiment of a filtration means as described elsewhere herein. In particular, filtration means 32 is representative of eluate filtration means present proximal to an outlet of an elution device. In some embodiments, the eluate filtration means is disposed proximal to an outlet and within the interior volume of an elution device. In some embodiments, eluate filtration means is disposed within a conduit fluidly attached to an outlet of an elution device; in some such embodiments the filtration means is proximal to an outlet. In some embodiments, eluate filtration means is disposed substantially co-continuously with an outlet of an elution device.

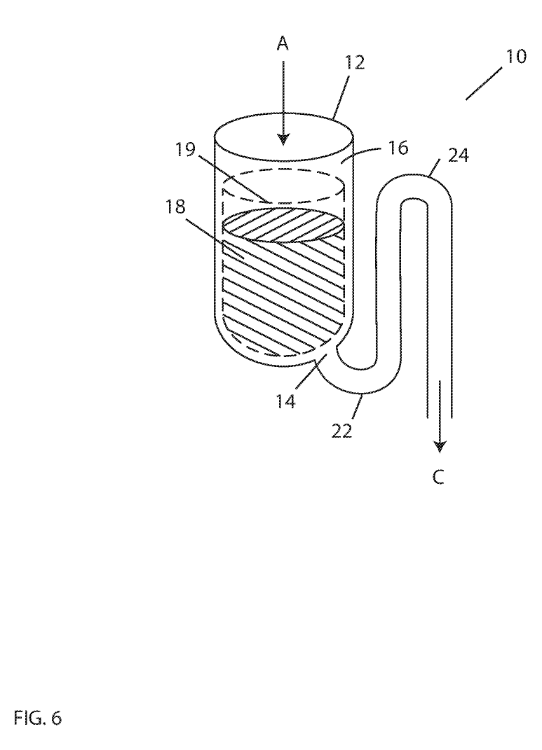

FIG. 6 shows elution device 10 having a curvilinear or rounded shape, further wherein outlet 14 is attached to eluate conduit 22 that includes a siphon mechanism 24. Eluant applied to inlet 12 of elution device 10 contacts slag 18; eluant continues to accumulate from inlet 12 until the liquid level 19 in elution device 10, and within eluate conduit 22, activates the siphoning action of siphon mechanism 24 to substantially empty elution device 10 of eluate.

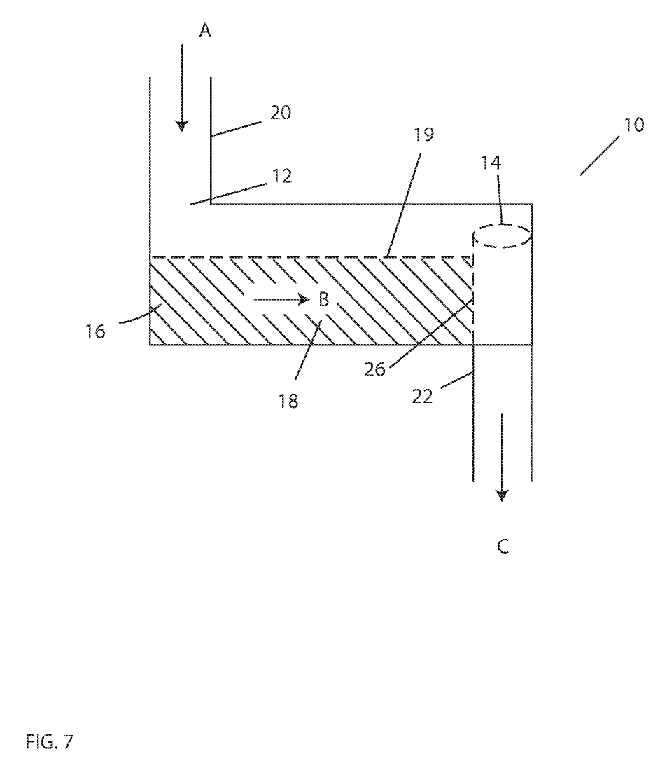

FIG. 7 is a side view of an elution device 10, wherein eluate outlet 14 is disposed within interior volume 16 to provide a weir portion 26. The interior volume 16 is partially filled with slag 18. Eluant applied to inlet 12 via eluant conduit 20 contacts slag 18; eluant continues to accumulate from inlet 12 until the level of liquid in elution device 10 reaches outlet 14. The level of slag 18 is lower than the level of outlet 14 due to weir portion 26. Thus, slag 18 is retained within inner volume 16 while eluate exits outlet 14 and proceeds through eluate conduit 22.

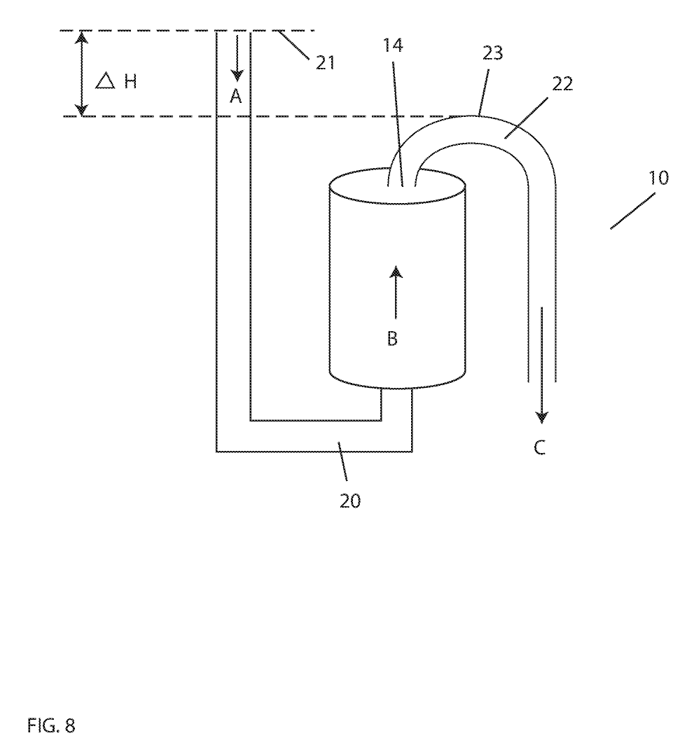

FIG. 8 shows a substantially cylindrically shaped elution device 10 in another elution system of the invention. Eluant applied to inlet 12 (not shown) via eluant conduit 20 contacts slag 18 (not shown); in this manner, liquid continues to accumulate within the device interior volume until the level of liquid in elution device 10 traverses outlet 14 and proceeds within eluate conduit 22 to the highest point 23 in eluate conduit 22 before proceeding in direction C within conduit 22. It will appreciated that such a device and system design is passive, as long as ΔH (difference in vertical distance) exists such that point 21 along eluant conduit 20 is higher than point 23 of eluate conduit 22 during application of eluant to conduit 20. When such a ΔH condition exists, a pressure differential (also referred to as hydraulic head or water head) arises when eluant is applied to conduit 20 that gives rise to gravity-mediated flow; that is, the flow of eluant into device 10, into contact with slag, and dispensation of eluate are all suitably carried out by force of gravity.

The eluant comprises, consists essentially of, or consists of water. Suitable eluants include any source of water that does not contain substantial amounts of compounds or materials that will precipitate when contacted with the steel slag. Suitable eluants include any source of water that does not include components that will substantially interfere with permeability and flow through the steel slag inside the elution device, for example compounds or materials that will precipitate when contacted with the steel slag. Suitable eluants include rain water, tap water, surface water, distilled water, deionized water, filtered water, and fresh water (that is, water obtained directly from a natural surface body of water such as a creek, lake, or river). In embodiments, the eluant is characterized as not including a substantial amount of compounds that can react with the steel slag or be filtered by the steel slag during movement of the eluant inside the elution system. In embodiments, the eluant is characterized as not including a substantial amount of phosphorus-containing compounds. It is desirable to maintain the integrity and the permeability of the steel slag within the elution device interior volume during use of the elution system. Thus, in some embodiments, one or more inlets or the interior volume of the elution device comprises filtration means to remove organic debris or particulate from the eluant prior to the eluant contacting the slag.

Suitable supports include any natural or man-made structure to which an elution system can be operably mounted. That is, the support is any structure capable of having an elution device attached thereto, wherein the attached elution device is situated such that gravity causes an eluant applied to an inlet of the elution device to flow from the inlet toward an outlet within the interior volume of the elution device, further wherein the flow causes the eluant to contact the steel slag and form an eluate. Further, when operably mounted within the elution system, the elution device is disposed substantially above ground level. Examples of suitable supports include buildings, vehicles, frames, surfaces, mobile frames, fences, gutters on buildings, natural features such as a rocks, cliffs, trees, hills, or mountains. In some embodiments, the surface of the earth is a suitable support, wherein “attached” or “mounted” means held in place by attachment means comprising, consisting essentially of, or consisting of gravity. In various embodiments and as determined by context, mounting means attaching the elution device to a support permanently, semi-permanently, or reversibly. In some embodiments, the support comprises or consists essentially of a building. In some embodiments the support comprises or consists essentially of a vehicle; in such embodiments, the elution system or elution device is mobile. In some embodiments, the support is the surface of the earth or the floor of a building. In some embodiments, the support includes a frame or brace adapted for operably mounting an elution device thereon. In some embodiments the frame or brace includes a vertical element. In some embodiments the frame or brace includes e.g. legs attached to the elution device to stabilize the device relative to the surface of the earth. Many related design elements and configurations lying within the scope of the support as described herein, and methods and articles employed to mount an elution device to a support, will be envisioned by one of skill based on the descriptions provided herein.

The elution device is mounted substantially above ground level during use. By “substantially above” it is meant that a substantial portion of the elution device is operably mounted above ground level. In some embodiments the entirety of the elution device is operably mounted above ground level. While it is possible to arrange the elution system partially below the ground, for example so that an outlet is situated beneath ground level, it is an advantage of the elution systems of the invention that the elution device operably mounted in a position that is accessible by users to inspect, replenish, or replace the contents thereof. Thus, in embodiments the elution device is operably mounted such that a substantial entirety of an elution device is situated above ground level. In some such embodiments one or more outlets contacts the surface of the earth. In other such embodiments, one or more outlets are disposed above the surface of the earth. In some such embodiments, an eluate conduit is fluidly attached to the one or more outlets on a first end thereof, and a second end thereof is situated proximal to, or in contact with the surface of the earth, a point below the surface of the earth, or a body of water.

In some embodiments, the elution device is operably mounted within the elution system such that the elution device is removably mounted; that is, the elution device can be separated from the remaining components of the elution system and inspected, replenished with additional steel slag, or replaced with a fresh elution device at the discretion of the user. It is an advantage of the elution systems of the invention that the elution devices are accessible in this way, as it provides a substantial benefit over filtration devices or other conventional devices that must be placed beneath ground level. Further, it is an advantage of the elution systems of the invention that the elution devices can be configured for removable mounting, which enables the user to inspect, replenish, or replace the elution device while the remaining components of the elution system remain assembled and/or mounted.

In some embodiments the elution system comprises, consists essentially of, or consists of an elution device operably mounted to a building. Thus in some embodiments, one or more elution devices are operably mounted to one or more buildings in order to address one or more distressed water sources in a selected geographic location. Additionally, if the amount of distressed water present in a selected location suddenly increases or decreases, one or more elution systems are easily assembled or disassembled, thereby addressing the specific treatment needs of a geographical location with ease. Disassembly includes, for example, removal of the elution device from the system, removal of an eluant conduit, or disposing a lid, valve, door, shutter, or other such mechanism proximal to one or more inlets of the elution device to prevent flow of eluant into the interior volume of the device.

In some embodiments, one or more inlets of the elution device are disposed proximal to a collector, wherein an eluant is collected in the collector, and the collected eluant is directed toward and through the one or more inlets. In some embodiments, the collecting and the directing are caused by gravity. When the elution device is operably mounted to the support, the collector is situated above the elution device. In some embodiments the collector is fluidly connected to an elution device inlet. In some embodiments the fluid connection includes a conduit disposed between and attached to the collector, to the elution device, or to both.

One example of a collector is a rooftop rain gutter of a building. Thus, in some embodiments, a gutter or rooftop drain attached to a building includes fluid communication between the gutter or drain and an elution device inlet. The elution device is operably mounted to the side of the building and further disposed to receive an eluant flowing from the gutter drain and through an inlet thereof. In some embodiments an eluant conduit is fluidly disposed between the gutter or drain and the inlet to gravitationally guide fluid flow toward and through an inlet of the elution device. In some embodiments one or more filtration means are disposed in the fluid flow path between the gutter or drain and the interior volume of the elution device.

Thus, in some embodiments, an elution system comprises, consists essentially of, or consists of an elution device operably mounted to the side of a building and further disposed to receive rain water applied from a gutter or drain, optionally through a conduit, and through the elution device inlet. In embodiments, no external energy sources are employed to operate the elution system: when rain falls, the passive eluant collection system, that is the gutter or drain, applies an eluant to the elution device solely by gravitational force. The elution device is situated within the elution system such that fluid flow facilitated by gravity causes the eluant to flow into the device interior volume and into contact with the slag, where it is transformed to an eluate by dissolving one or more solutes from the slag. The eluate continues to flow toward an outlet of the elution device and is dispensed therefrom toward the surface of the earth, toward a point beneath the surface of the earth, into a body of water, or into a container for storage and future use or for metered use. Since the entire operation of such the elution system occurs without application of external force, such a system is a passive system. In some embodiments, mounting a passive system requires mounting the elution device below a passive eluant collection system. Another suitable example of a passive eluant collector is a a catchment area such as a tray, bowl, or any surface characterized by high rainwater runoff; the passive eluant collector is situated to collect rain water and includes a drain outlet defined thereon, wherein the drain outlet is in fluid communication with an inlet of the elution device.

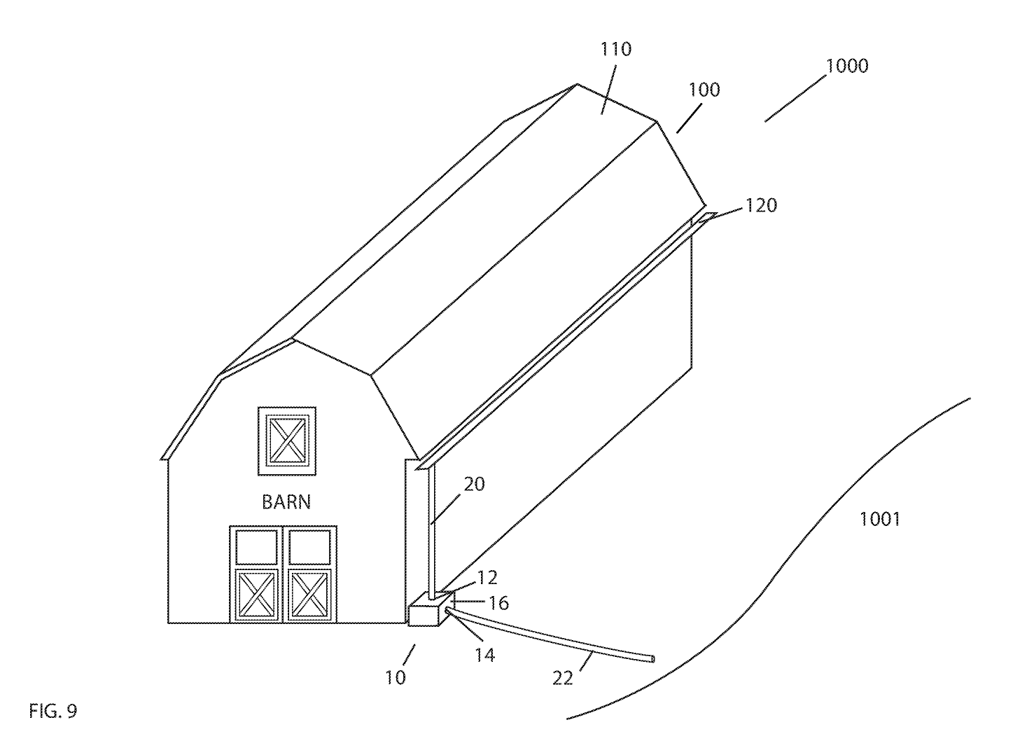

FIG. 9 shows an elution system of the invention. Elution system 1000 includes elution device 10 operably mounted to building 100. Building 100 includes roof 110 and rain gutter 120 fluidly connected to eluant conduit 20; conduit 20 is fluidly connected to inlet 12 of elution device 10. Rain falling on the roof 110 flows into rain gutter 120 and then into conduit 20, where it is applied to inlet 12 of elution device 10. The eluant rain water proceeds to enter interior volume 16 of device 10, where it contacts slag within device 10. After contacting the slag, an eluate exits through outlet 14 of device 10 and and into eluate conduit 22. Eluate conduit 22 directs a flow of eluate toward a distressed water source, 1001, that is a surface water source.

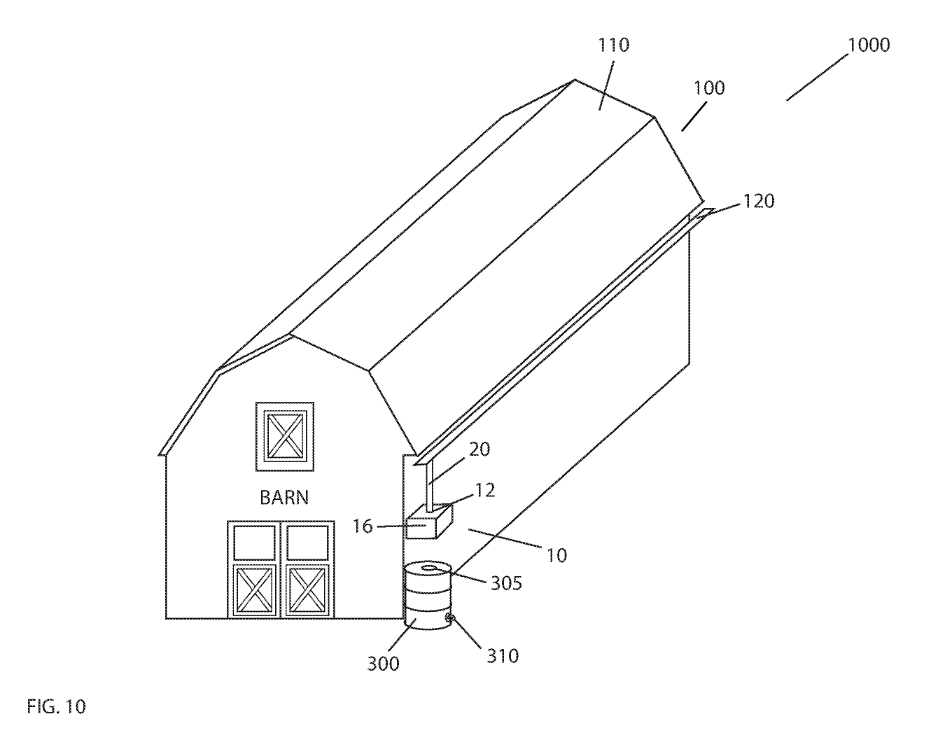

FIG. 10 shows another elution system of the invention. Elution system 1000 includes elution device 10 operably mounted to building 100. Building 100 includes roof 110 and rain gutter 120 fluidly connected to eluant conduit 20; conduit 20 is fluidly connected to inlet 12 of elution device 10. Rain falling on the roof 110 flows into rain gutter 120 and then into conduit 20, where it is applied to inlet 12 of elution device 10. The eluant rain water proceeds to enter interior volume 16 of device 10, where it contacts slag within device 10. After contacting the slag, an eluate is dispensed through an outlet (not shown) of device 10 and flows into sealable holding tank 300 via tank inlet 305.

Tank 300 further includes valve means 310 for dispensing the eluate as a metered and/or on-demand flow. Valve means 310 of sealable holding tank 300 is opened or closed by a user to provide on-demand or metered flow of eluate directly to the ground or toward a distressed water source. In the embodiment shown in FIG. 10, tank 300 is not attached to device 10 or to building 100 and can be moved by a user before or after eluate is dispensed therein. Thus, for example, in some alternative embodiments tank 300 is e.g. on wheels or provided with other means for mobility such that the tank 300 is suitably used as needed, further as directed by a user of the elution system 1000. Optionally, a conduit such as any of the previously described eluate conduits is fluidly connected to valve means 310 of tank 300 to direct an eluate flow from tank 300 as selected by a user, further wherein the eluate flow is provided on demand or in metered fashion by the user opening the valve means 310. In some such embodiments, the eluate conduit is removably attached to valve means 310.

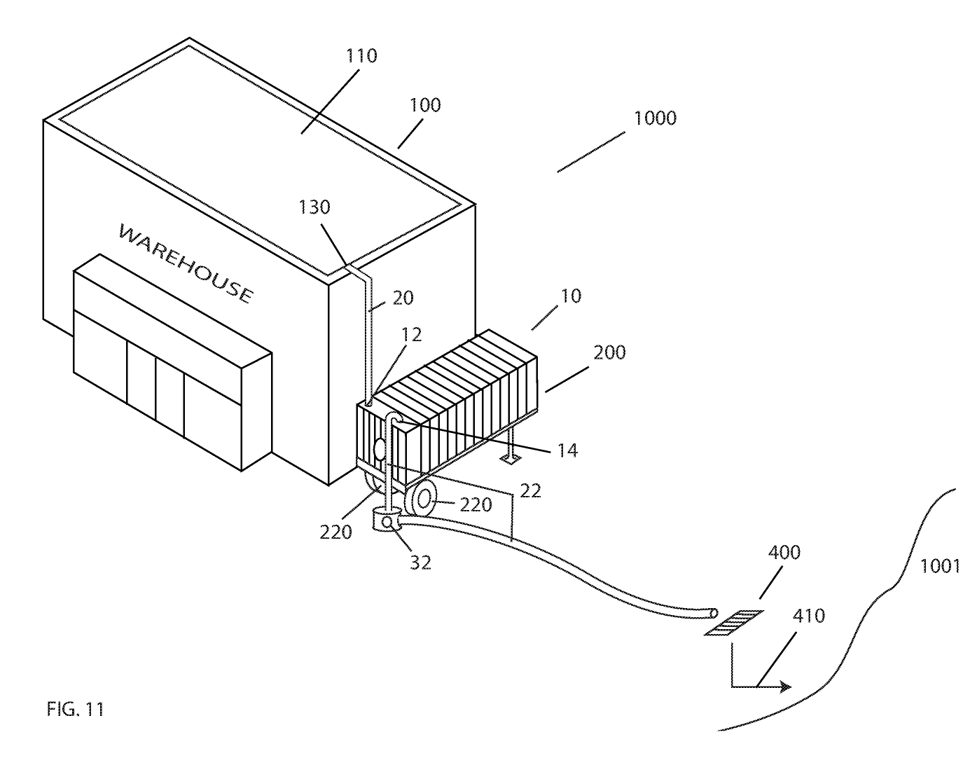

FIG. 11 shows a transportable elution system of the invention. Elution system 1000 includes elution device 10 that is also a mobile container 200. Container 200 is operably mounted by positioning the device on the ground substantially as shown, constituting a self-contained mobile elution system. Container 200 defines an interior volume (not shown) including slag. Container 200 further includes wheels 220 and linking apparatus (not shown) for linking the container 200 to a motor vehicle such as a tractor trailer cab. Container 200 further includes inlet 12 and eluant conduit 20. Building 100 includes roof 110 and rooftop drain system 130 fluidly connected to eluant conduit 20. Conduit 20 is fluidly and removably attached to drain system 130, or to inlet 12, or to both drain system 130 and inlet 12. Rain falling on roof 110 flows toward and into drain system 130 and through conduit 20, where it is applied to inlet 12 of container 200. The eluant rain water proceeds to enter the interior volume of container 200, where it contacts slag. After contacting the slag, an eluate exits from outlet 14 and through eluate conduit 22. Filtration means 32 is disposed and fluidly connected within eluate conduit 22 to remove macroscopic slag particulate, if any, flowing through conduit 22. Eluate is dispensed into, proximal to, and/or directed toward a sewer or pipe inlet 400. Eluate flowing through inlet 400 proceeds within a subterranean path 410 toward surface water source 1001, which is or comprises a source of distressed water. In some embodiments, subterranean path 410 is a sewer system or rainwater drainage system; in some such embodiments, path 410 includes a source of distressed water.

In an embodiment, the mobile container 200 as shown in FIG. 11 is advantageously transported using a tractor trailer cab to haul the container 200 from a first location to a second location, wherein the second location is proximal to a distressed water source or other location in need of remediation. It will be understood that container 200 is fully operably mounted whether or not it is attached to a building, such as building 100 of FIG. 11, or another source of eluant such as a municipal water source, alternative source of catching rain water, pump operably situated to provide water from a surface water source, or some other water source. Further, container 200 as shown in FIG. 11 is advantageously transported either “dry”, that is, having substantially no eluant or eluate within container 200, or having some portion of interior volume therein filled with eluate. In some embodiments, it is advantageous to remove, close, and/or store conduits 20, 22, or both; in some embodiments it is advantageous close one or more of inlet 12 and/or outlet 14. One of skill will understand how to accomplish such removing, closing, and storing steps in order to safely transport container 200 whether or not container 200 includes eluate within the interior volume thereof.

In an embodiment alternative to FIG. 11, filtration device 32 is, in addition to or instead of filtration device 32, a pump device. Filtration means and pump device 32 is employed to pump an eluate from container 200 via outlet 14 and conduit 22 on demand and as selected by the user to dispense an eluate proximal to a distressed water source such as surface water source 1001, which is or comprises a source of distressed water.

In some embodiments, one or more inlets of an elution device are connected to two or more different eluant sources. For example, in some embodiments a first inlet is fluidly connected to a first source of eluant, such as rain water, and a second inlet is fluidly connected to a second source of eluant that is different from the first source, such as tap water. In other embodiments, a first inlet is attached to a first source of eluant that is a first rainwater source, such as a first rain water catchment; and a second inlet is attached to a second source of eluant, such as a second rain water catchment. In some embodiments, one or more rain collectors are directed to a central holding unit for eluant, such as a rain collection pond or a device such as a landfill cover, solar array, or pond cover, and the combined eluant is applied to an elution system. The first and second eluants flow contemporaneously or separately into the elution device, as selected by the user or by the equipment manufacturer for a particular use. The first and second eluants flow independently or codependently into the elution device, as selected by the user or by the equipment manufacturer for a particular use. More than two eluant sources can be used; it is an advantage of the elution systems of the invention that multiple eluant sources are easily applied to the elution device.

Further, by dispensing eluate from the elution device into a mobile container, the eluate is useful in a flexible manner to treat two or more distinct distressed sources of water or other material in need of treatment using highly alkaline (pH of about 11 to 14) eluate. A mobile container is one that is capable of physical relocation while carrying eluate. Thus, a truck bed suitable for carrying eluate and having at least two wheels attached thereto, means to attach the truck bed to a truck cab, and at least one dispensing outlet or conduit for transferring eluate from the truck bed to a site proximal to a distressed water source is a suitable mobile container. Similarly, a 55-gallon drum with wheels on the bottom thereof, suitable for transporting the drum by hand and having a spigot on the side thereof is a suitable mobile container. In still other embodiments, a mobile elution system such as those mentioned elsewhere herein further includes a container attached thereto for receiving and holding eluate for later dispensation; in such embodiments, the elution system and container are situated on a single mobile unit.

In some such embodiments, the entirety of the elution device is mounted operably within the interior of a truck bed or other mobile format. In such embodiments the entire system is mobile; where the mobile format is a truck bed, the elution system can include the truck bed as a support, wherein the elution system is further contained within a single, road-ready format that is easily transported using conventional means such as a tractor-trailer cab. In other embodiments, a support other than the truck bed is employed to operably mount the elution device thereto, and the truck cab is functionally employed to hold and move the elution system; in some such embodiments the truck bed is or includes a container for holding eluate. Such a self-contained elution system is advantageously parked in a location proximal to an eluant source or to a distressed water source. A self-contained elution system is employed to carry out at least two of the following: capture eluant from one or more sources; move eluant from a first location to a second location; form eluate; store eluate in a container; move eluate from a first location to a second location; and dispense eluate at a selected location proximal to a distressed water source. In some embodiments, such a unit having an eluant applied thereto forms and stores eluate in a mobile format that can be moved before, during, or after eluate formation so that eluate is advantageously dispensed at one or more sites proximal to one or more distressed water sources.

In some embodiments, the elution system is designed and adapted to passively receive an eluant, wherein gravitational force urges the eluant through an inlet of an elution device, into contact with the steel slag within the elution device interior volume, and through at least one outlet of the elution device. In other embodiments, the elution system is designed and adapted to receive an eluant applied using an external force. For example, in an exemplary embodiment, tap water is applied to the elution device employing a source of pressure such as a pump.

In some embodiments, the elution system comprises an elution device removably mounted to the support. In such embodiments, the elution system comprises one or more removable attachment means.

In some embodiments, the elution systems are transportable, that is, they can be disassembled, the elution device moved to a new location, and reassembled with ease. In some embodiments, the systems are mobile. Mobile elution systems are those mounted on a vehicle, for example a truck bed, capable of physically moving the entire system from a first location to a second location without disassembly; alternatively, mobile systems those that can be assembled and mounted on an immobile or mobile support, then disassembled, transported or stored, then reassembled and mounted on a same or different support, for example in a different location having a distressed water source in need of treatment. In some embodiments, an elution system such as a transportable or non-transportable elution system includes a standalone eluant supply and, in some such embodiments, a pump or other means to apply the eluant to the elution device. Providing an eluant tank or other container enables formation of an eluate on demand, and further at any location when the elution system is transportable.

In some embodiments, the elution system is designed and adapted to be assembled and further subjected to one or more disassembly/reassembly cycles. In some such embodiments, the assembled elution system comprises a first support, and the reassembled elution system comprises a second support that is different from the first support. In some embodiments, the elution system includes one or more removable attachment means designed and adapted to removably attach one or more portions of an elution device or a conduit fluidly attached thereto to the first support, second support, and subsequent supports in the case of two or more disassembly/reassembly cycles. In some embodiments, a single elution system is capable of undergoing between about 2 and 500 disassembly/reassembly cycles.

In some embodiments, an inlet of the elution device is disposed proximal to a water collector, such that water collected in the water collector is directed toward and through the inlet by gravitational force. In some such embodiments, a water collector is fluidly attached to one or more elution devices within one or more elution systems of the invention. In some such embodiments, one or more eluant conduits are disposed between and in fluid connection with the water collector, one or more device inlets, or both the water collector and one or more device inlets. In some embodiments, one or more device outlets are fluidly connected to one or more eluate conduits designed and adapted to receive an eluate dispensed from an elution device and direct the eluate to a selected location for dispensing onto or below the surface of the earth or into a body of water.

In some such embodiments, the elution device is operably mounted to the support by attaching one or more conduits to the device and attaching one or more of the conduits to the support employing suitable attachment means. Suitable conduits include eluant conduits and eluate conduits.

In some embodiments an elution device, the support, or both further include one or more attachment means to operably mount the device to the support. Suitable attachment means include one or more clips, latches, brackets, screws, nails, snaps, buttons, ties, clamps, straps, adhesive compositions, hook and loop or other mating fasteners, combinations of these, and similar items as well as adjunct equipment including braces, extension bars, brackets, handles, and the like as will be familiar to those of skill. In some embodiments, attachment means include gravity. In such embodiments where attachment means are employed, assembling the elution system includes applying one or more attachment means to operably mount the elution device to the support. In some embodiments, an elution device is both operably and removably mounted to the support.

In some embodiments, the elution device is designed and adapted to receive two or more eluants. The two or more eluants are applied to one or more inlets of the elution device independently or codependently. The two or more eluants are applied to one or more inlets of the elution device contemporaneously or at separate times. In some embodiments, the two or more eluants comprise, consist essentially of, or consist of water, rain water, tap water, fresh water, or a combination of two or more thereof. In some embodiments a first eluant is applied passively to one or more inlets of the elution device and a second eluant is applied to one or more inlets of the elution device under an applied pressure.

Method of Treating

Described herein is a method of treating a distressed water source, the method comprising applying an eluant to an inlet of an elution device, the elution device operably mounted on a support; and dispensing an eluate from an outlet of the elution device, wherein the dispensing causes the eluate to contact a source of distressed water. In some embodiments, the applying is passive. The eluant flows from the inlet toward the outlet of the elution device. In some embodiments, the flow is facilitated by gravity and no external force is applied to urge the flow toward the outlet. In other embodiments, flow is facilitated by the use of a pressure source; tap water, fire hydrant water, and process water are non-limiting examples of pressurized sources of eluant. Steel slag is disposed within at least a portion of the interior volume of the elution device and situated in the flow path between the inlet and the outlet. The eluant contacts the slag for an amount of time sufficient to form an eluate.

The elution device is designed and adapted to be operably mounted to receive a fluid flow through an inlet, into the interior volume thereof, and toward an outlet, further wherein the fluid contacts the steel slag disposed therein. The fluid flow is dispensed from the outlet onto the surface of the earth, below the surface of the earth, or into a body of water proximal to a source of distressed water. The fluid flow dispensed from the outlet is an eluate formed within the elution device by contacting an eluant with the steel slag for a sufficient amount of time to dissolve one or more solutes in the eluant, wherein the solutes are derived from the slag. The eluate contacts the distressed water to form a treated water.

The eluate comprises, consists essentially of, or consists of the eluant and one or more solutes dissolved therein, wherein the solutes are derived from the slag. In embodiments, solutes found in the eluate comprise one or more of calcium, magnesium, silicon, and boron. Solute composition of a slag eluate varies with both pH of the eluant and particle size of the slag. Thus, the eluate is suitably manipulated to provide the balance of desired solutes for a particular application, such as chemical treatment of water sources including e.g. groundwater or industrial water; use of the solutes as reagents or catalysts in an industrial chemical process; or fertilization of living plants. In one such embodiment, the eluate is usefully dispensed onto the surface of the earth, or below the surface of the earth, or into a body of water, wherein the dispensing is proximal to one or more distressed water sources. In some embodiments, the eluate is collected in a container for storage and future dispensing proximal to one or more distressed water sources, or to facilitate metered application to one or more locations proximal to one or more distressed water sources. In some embodiments, the storage container is a mobile container. In some embodiments, the eluant is a water source such as deionized water, distilled water, tap water, rain water, water pumped from a municipal, commercial, or underground source such as well water, water from a water tower or rain water reservoir, or the aqueous byproduct of an industrial process; or water from a natural body. In any one or more such embodiments, eluant is applied using a source of pressure. In some embodiments, the eluant/eluate flow path is part of a loop in a water remediation process; such embodiments are described further below. In such embodiments, it is said that the eluate is dispensed in line with a process.

When the eluant contacts the slag, solutes are derived therefrom and dissolve in the eluant to form an eluate. The solutes cause the pH of the eluate to be higher than the pH of the eluant. Thus, in some embodiments, the methods of the invention include applying an eluant to an elution device, the eluant having a first pH; contacting the eluant with steel slag disposed within the elution device to form an eluate, the eluate having a second pH that is greater than the first pH; and dispensing the eluate proximal to a distressed water source. In some embodiments, the first pH is about −1 to 8, or about 0 to 8, or about 1 to 8, or about 2 to 8, or about 3 to 8, or about 4 to 8, or about 5 to 8, or about 6 to 8, or about 7 to 8, 8, or about 4 to 7.5, or about 4 to 7, or about 4 to 6.5, or about 4 to 6, or about 4 to 5.5, or about 4 to 5, or about 4.5 to 7.5, or about 4.5 to 7, or about 5 to 7.5, or about 5 to 7. In embodiments, the second pH is about 12 to 14, or about 12.1 to 14, or about 12.2 to 14, or about 12 to 13.8, or about 12 to 13.6, or about 12 to 13.4, or about 12 to 13.2, or about 12 to 13, or about 12.2 to 13, or about 12 to 12.9, or about 12 to 12.8, or about 12 to 12.7. In some embodiments, the second pH is about to 4 to 9 pH units higher than the first pH, or about 4.5 to 9, or about 5 to 9, or about 5.5 to 9, or about 6 to 9, or about 6.5 to 9, or about 7 to 9, or about 7.5 to 9, or about 8 to 9, or about 8.5 to 9, or about 4 to 8.5, or about 4 to 8, or about 4 to 7.5, or about 4 to 7, or about 4 to 6.5, or about 4 to 6, or about 4 to 5.5, or about 4 to 5, or about 4 to 4.5 pH units higher than the first pH.

The substantial cause of the difference in pH between the eluant and the eluate is calcium compounds eluted from the slag as solutes in the eluate. In some embodiments, calcium hydroxide (Ca(OH)₂ or CaO:H₂O) is a substantial portion of the solute in the eluant; in some embodiments calcium hydroxide represents substantially the entirety of the solute in the eluate. In embodiments, the eluate comprises about 1 mM to 1000 mM calcium hydroxide, or about 5 mM to 1000 mM, or about 8 mM to 1000 mM, or about 8 mM to 1000 mM, or about 10 mM to 1000 mM, or about 20 mM to 1000 mM, or about 30 mM to 1000 mM, or about 40 mM to 1000 mM, or about 50 mM to 1000 mM, or about 60 mM to 1000 mM, or about 70 mM to 1000 mM, or about 80 mM to 1000 mM, or about 90 mM to 1000 mM, or about 100 mM to 1000 mM, or about 1 mM to 900 mM, or about 1 mM to 800 mM, or about 1 mM to 700 mM, or about 1 mM to 600 mM, or about 1 mM to 500 mM, or about 1 mM to 400 mM, or about 1 mM to 300 mM, or about 1 mM to 200 mM, or about 1 mM to 100 mM, or about 10 mM to 500 mM, or about 10 mM to 250 mM, or about 50 mM to 500 mM, or about 100 mM to 500 mM calcium hydroxide. One of skill will appreciate that the concentration of calcium hydroxide in the eluate is a function of both the amount of eluate previously eluted from the slag and the retention time of the eluant within the device (that is, contact time with the slag), which in turn is a function of the selected elution device design, amount of slag in the device, particle size of the slag, and flow rate of eluant into the device.

The eluant is contacted with the slag within the interior volume of the elution device. In embodiments, such contact extends for an amount of time suitable to form an eluate capable of forming a treated water when the eluate is contacted with a distressed water. Where the distressed water includes one or more phosphate species, a sufficient time of contact is the amount of time required to form an eluate having a pH of greater than 7, in some embodiments at least 9, and in some embodiments as high as about 13. In some embodiments, a sufficient time of contact of the eluant with the slag is about 10 seconds to 10 days, or about 10 seconds to 9 days, or about 10 seconds to 8 days, or about 10 seconds to 7 days, or about 10 seconds to 6 days, or about 10 seconds to 5 days, or about 10 seconds to 4 days, or about 10 seconds to 3 days, or about 10 seconds to 2 days, or about 10 seconds to 1 day, or about 10 seconds to 10 hours, or about 10 seconds to 9 hours, or about 10 seconds to 8 hours, or about 10 seconds to 7 hours, or about 10 seconds to 6 hours, or about 10 seconds to 5 hours, or about 10 seconds to 4 hours, or about 10 seconds to 3 hours, or about 10 seconds to 2 hours, or about 10 seconds to 1 hours, or about 10 seconds to 50 minutes, or about 10 seconds to 40 minutes, or about 10 seconds to 30 minutes, or about 10 seconds to 20 minutes, or about 10 seconds to 10 minutes, or about 10 seconds to 9 minutes or about 10 seconds to 8 minutes, or about 10 seconds to 7 minutes, or about 10 seconds to 6 minutes, or about 10 seconds to 5 minutes or about 10 seconds to 4 minutes, or about 10 seconds to 3 minutes, or about 10 seconds to 2 minutes, or about 10 seconds to 1 minute, or about 10 seconds to 30 seconds, or about 20 seconds to 1 hour, or about 30 seconds to 1 hour, or about 1 minute to 1 hour, or about 1 minute to 5 minutes, or about 1 minute to 10 minutes, or about 10 hours to 10 days, or about 1 day to 10 days, or about 1 day to 5 days. In some embodiments, the contact time of the eluant with the slag is the retention time within the elution device.

The eluate advantageously does not include substantial amounts of heavy metals. Ziemkiewicz, Proceedings of the 1998 Conference on Hazardous Waste Research, May 18-21, 1998, Snowbird, Utah; p. 44-62 (available for download at https://www.engg.ksu.edu/HSRC/98Proceed/5Ziemkiewicz/5ziemkiewicz.pdf) determined that basic steel slags do not leach heavy metals in excess of 1998 EPA TCLP test standards. Further, when basic steel slag leachate was tested against 1998 EPA drinking water standards, aside from alkalinity (pH) the only material in the leachate to exceed the criteria was nickel (41 μg/l leached vs. 10 μg/l=criteria).

Distressed waters, or distressed water sources, comprise one or more contaminants dissolved or dispersed therein. In some embodiments, a distressed water source includes one or more contaminants occurring at total and/or dissolved concentrations above voluntarily accepted criteria. In some embodiments, a distressed water source includes one or more contaminants occurring at total and/or dissolved concentrations above compulsory regulated criteria. In some embodiments, a distressed water source includes one or more compounds in excess of one or more local regulations or other applicable water quality guidelines for release of the water into the environment, wherein the treated water formed from contact of the eluate with the distressed water comprises a lower concentration in the one or more of the compounds than the distressed water or an associated soil amendment containing the distressed water. In some embodiments, the one or more compounds are phosphorus, sulfur, and/or nitrogen containing compounds.

Phosphorus contaminants include orthophosphates, polyphosphates, and metaphosphates. These compounds and/or ions enter ground water or runoff streams, and eventually flow into lakes, ponds, rivers, estuaries, and the ocean from various sources such as plant, tree, and crop fertilizers, agricultural and food processing activities, mining and mineral processing activities, fertilizer manufacturing, phosphate-treated firing ranges, wastewater treatment from municipal sources, runoff from feed lots, soaps and detergents, and other private and industrial processes. Orthophosphates and condensed phosphates are highly soluble in water. Phosphates are a primary limiting factor in fresh water plant and algal growth. Thus, increased amounts of phosphates in a water source tend to cause accelerated plant and algae growth in rivers and lakes, in some cases causing dense growth of algae and plants referred to as an “algal bloom”. A phosphate level of just 0.025 mg/liter will result in an increase in growth of plant life.

In temperate freshwater environments, seasonally active plants die in the fall and other vegetative growth decreases substantially. Dead and decaying plant materials are decomposed by aerobic bacteria which can deplete the oxygen content in the water. This oxygen depletion causes oxygen-respiring aquatic organisms to die. Anaerobic bacteria assume the role of decomposition under conditions of very low oxygen concentrations. In the breakdown of the organic material by anaerobes, toxic byproducts such as ammonium compounds and hydrogen sulfide are often produced. The natural eutrophication process is thereby accelerated by human activities, primarily by the introduction of excess phosphates into the water. This acceleration is sometimes referred to as “cultural eutrophication.”

Thus, in an exemplary embodiment, disclosed herein is a method for reducing phosphate contaminants dissolved or dispersed in one or more water sources. The water source is a distressed water present as groundwater, surface water, process water, or another water source including one or more phosphate contaminants in need of reduction or removal. The method comprises applying an eluant to an inlet of an elution device, the elution device operably mounted on a support; and dispensing an eluate from an outlet of the elution device, wherein the dispensing causes the eluate to contact a distressed water source comprising one or more phosphate contaminants. Upon contact with the contaminants, solute dissolved in the eluate react with and/or cause precipitation of one or more contaminants from the distressed water to form a treated water. An exemplary chemical equation for the reaction of a phosphate ions with an exemplary solute to form a precipitated calcium phosphate phase (a pyromorphite) is presented below, where (ppt) denotes a compound or ion that is insoluble in water (precipitate).

5Ca²⁺+3PO₄³⁻+X⁻↔Ca₅(PO₄)₃X (ppt)

[X═OH, Br, Cl, F, other anionic species, or a combination of two or more thereof]

In some embodiments, the methods of the invention further include inspecting, replenishing, and/or replacing the slag; inspecting and/or replacing the elution device, inspecting and/or replacing one or more filtration means, inspecting and/or replacing one or more attachment means, inspecting and/or replacing one or more conduits, and other inspection, maintenance or repair activities. Inspection activities include, for example, testing the pH and/or calcium concentration of the eluate issuing from an elution device to determine if the slag needs to be replenished. Such activities are easily accomplished using the elution systems of the invention due to their simple construction and the disposition of the elution device substantially above the surface of the earth.

If the amount of phosphate in the ground or surface water proximal to the elution system increases (e.g. when a crop field is fertilized), or decreases (such as when farming or industrial processes are ceased) the ease of implementation of the systems allows for simple modifications to add one or more additional elution devices or systems, or alternatively to disassemble, cap off, or otherwise disable an elution system, thereby addressing the specific needs of a geographical location with ease.

In some embodiments, the eluate is a pre-treatment material. That is, the eluate treats a distressed water that then is subjected to additional treatment steps. Thus, for example, within a water treatment plant, the elution device can be mounted to a building or frame to form an elution system that delivers eluate to a distressed water, forming treated water. The treated water includes one or more additional impurities either prior to or after contacting the eluate; thus, the treated water may be further processed to remove additional impurities employing conventional methods. For example, precipitates formed in a distressed water after contact with the eluate are filtered from the water. Similarly, apparatuses and devices such as containers or treatment ponds for aqueous and non-aqueous chemical wastes benefit from application of an eluate thereto to provide a partial treatment of chemical waste products within ground water or within a non-aqueous chemical waste pit.

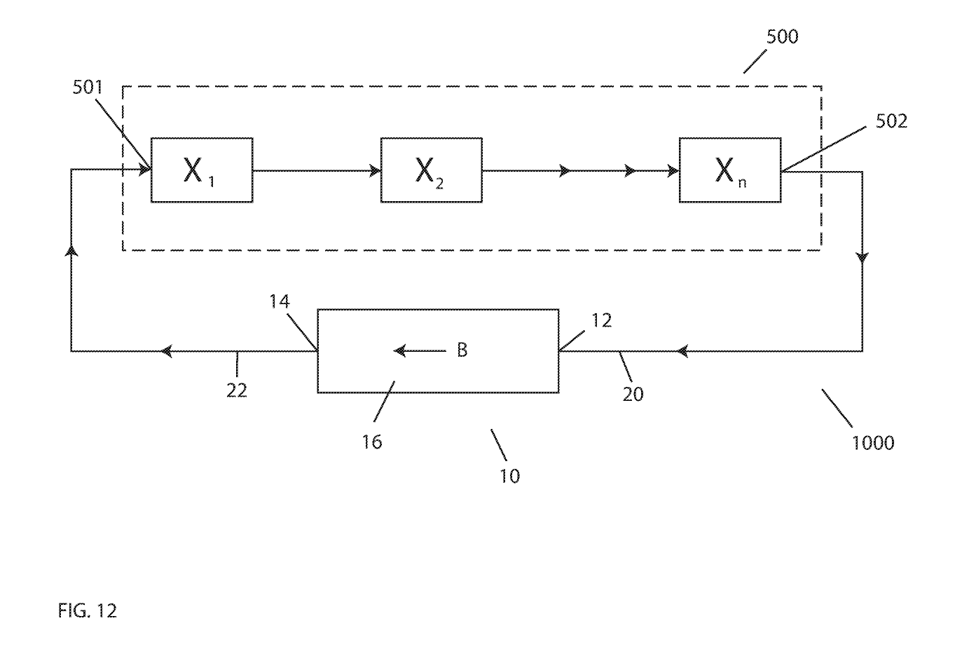

In some embodiments, the eluant-eluate flow path is a portion of an overall water treatment loop. One example of such a treatment loop is provided in FIG. 12. Elution device 10 is operably mounted to water treatment apparatus 500 to form elution system 1000. Eluant is applied to device inlet 12 via eluant conduit 20 and proceeds to device interior volume 16, where it contacts slag. Eluate is formed within the interior volume 16 and is then dispensed from device outlet 14 where it follows eluate conduit 22 to a first inlet 501 of treatment apparatus 500. Apparatus 500 includes one or more treatment modules X₁, X₂, . . . Xₙ; modules Xₙ include inlets, outlets, and various treatment components for removing one or more contaminants from a distressed water, including precipitated species formed by reaction of one or more contaminants with the eluate. Where the flow path exits apparatus Xₙ at a final module Xₙ outlet 502, the flow includes an eluant which is then applied to inlet 12 via conduit 20. In some embodiments, conduit 20 carries a portion of the flow path exiting apparatus Xₙ at final outlet 502, whereas the remainder of the flow path is directed elsewhere. Additional flow paths, not shown, lead one or more additional materials to other areas of the treatment apparatus or to one or more containers for storage, provide additional reagents or materials to the apparatus, and the like as will be appreciated by one of skill in the art of water treatment plants. In some embodiments in addition to, or in place of, the flow path from outlet 14 to inlet 501 via conduit 22, one or more conduits 22 lead from one or more outlets 14 of device 10 to one or more Xₙ treatment modules, whereby eluate is suitably dispensed to carry out one or more treatments of distressed water. In this manner, one or more different contaminants are addressed employing a single elution device.

In some embodiments, the eluate is dispensed as a treatment solution, wherein one or more compounds in the eluate provide a particular benefit in addition to or other than those described above. For example, in some embodiments an eluate is dispensed onto or within one or more of a crop field, potting soil, wetlands, garden area, pasture, arboretum, vineyard, golf green, hydroponic application or other area having living plants thereon or therein. Alternatively, in some embodiments an eluate is dispensed onto or within media designed and adapted to be contacted with one or more living plants. Such media includes potting soil, topsoil, fertilizer solutions or dispersions, or another materials associated with beneficial contact with a living plant. In some such embodiments, an eluate is caused to contact the living plants and/or the soil proximal to the plants, where it benefits the plants by providing one or more compounds to promote the growth thereof, improve pest, blight and drought resistance thereof, or some other benefit.

Thus, in some embodiments, the elution system further includes a distribution system suitable to distribute eluate over a substantial area of the surface of the earth, such as from 1 m² to 100 km². Such areas may include, for example, a crop field, vineyard, garden area, golf green, or the like, wherein eluate is distributed among a plurality of living plants. Suitable means to distribute the eluate include irrigation manifolds, drip irrigation systems, metering pumps, spray booms, and the like. Distribution may be conducted substantially contemporaneously with eluate dispensation, or an eluate may be stored in a tank or other vessel as described above until distribution is desired. The eluate may be distributed “neat” or alternatively by diluting the eluate with water or a mixture of water and one or more other chemicals dissolved therein to prior to distribution.

### EXPERIMENTAL

### Example 1

A column having an inner diameter of 10.2 cm (4 in.) was fabricated from an inert PVC cylinder. Column endplates were also made from clear PVC material (similar to the PVC cylinders) and were attached using eight, 0.6 cm (¼ in.) threaded screws. The gaskets (o-rings) at each end of the columns were fabricated of inert neoprene and were 0.24 cm ( 3/32 in.) thick. The PVC cylinder and disks along with the neoprene gaskets were checked to ensure chemical compatibility with steel slag fines (SSF) and water contacted with SSF.

Then the column was prepared in accordance with ASTM D4874 (Standard Test Method for Leaching Solid Material in a Column Apparatus) to contain steel slag fines (SSF). Freshly crushed SSF (9.5 mm (⅜ in.) maximum) were provided at their natural moisture contents. The column was packed with approximately 5.2 kg of the SSF to achieve a minimum 95% of relative compaction of maximum dry density based on the Standard Proctor method (ASTM D698). Based on the aspect ratio (H/L) considerations of the column, the compacted height of SSF in the column was 30.5 cm (12 in.). Overall column length of 36.8 cm (14.5 in.) was selected to accommodate a 5 cm (2 in.) long eluant reservoir placed at the bottom of the column to promote uniform flow.

Flow distribution disks were placed at both ends of the column. The disks were made of sintered stainless steel with a nominal pore diameter of 70 μm. The disk diameters matched columns inside diameter of 10.2 cm (4 in.) with a thickness of 0.6 cm (¼ in.). The eluant port disk was placed at a height of approximately 5 cm (2 in.) above the bottom of the column plate to facilitate the uniform distribution of eluant into the column. Then 20 μm filter paper was placed on each side of the packed SSF media to facilitate uniform distribution of flow into the column and prevent migration of fine SSF particles through the disks.

An average water flow velocity of 0.00092 cm/sec was selected to simulate groundwater flow in a poorly graded sand under hydraulic gradient of about 0.001 to 0.0001 m/m. The average flow rate corresponded to a volumetric injection rate of 4.5 ml/min. The column was determined to have a porosity of approximately 37% and a retention time of 3.5 hours. The retention time corresponds to the passage of one pore volume through the entirety of the column.

The elution process was conducted in a continuous up-flow mode to promote saturated flow conditions and to mitigate short circuiting of flow. The columns were first saturated using de-ionized (DI) water having a pH=5.6 by applying a vacuum to the column for 24 hours; then DI water was pumped through the column at 20 mL/min for up to two pore volumes or until no air bubbles were observed in the column A 19 L (5-gallon) self-supporting polyethylene tank was used to prepare and hold additional DI water as eluant. The tank was refilled about every two days. A peristaltic pump was used to introduce the DI water into the columns. Liquid eluting from the column was sampled at over number of pore volume intervals for a total duration of about 100 pore volumes.

The eluted Ca, Fe and Mg concentrations and the corresponding pH values of the eluate are presented in Table 1. Eluted Ca concentrations ranged from 525 mg/L to 1,195 mg/L and the total mass of eluted Ca was estimated at approximately 64,750 mg, which is approximately 4% of the total Ca (330,000 mg/kg) present in the SSF media. The Fe and Mg concentrations were consistently below the detection limit (DL=0.05 mg/L) for the entire test duration. The effluent pH ranged between 12.18 and 12.64 as shown in Table 1.

TABLE 1
Content of Ca, Fe, and Mg in the eluate at the indicated pore volume.

| Pore | | Ca | Fe | Mg |
|---|---|---|---|---|
| Volume | pH | (mg/L) | (mg/L) | (mg/L) |
| 1 | 12.19 | 1,060 | <0.05 | <0.05 |
| 2 | 12.26 | 933 | <0.05 | <0.05 |
| 4 | 12.18 | 750 | <0.05 | <0.05 |
| 7 | 12.20 | 720 | <0.05 | <0.05 |
| 8 | 12.19 | 671 | <0.05 | <0.05 |
| 9 | 12.19 | 560 | <0.05 | <0.05 |
| 11 | 12.34 | 1,195 | <0.05 | <0.05 |
| 15 | 12.39 | 733 | <0.05 | <0.05 |
| 15 | 12.39 | 853 | <0.05 | <0.05 |
| 16 | 12.36 | 764 | <0.05 | <0.05 |
| 18 | 12.28 | 811 | <0.05 | <0.05 |
| 22 | 12.37 | 692 | <0.05 | <0.05 |
| 23 | 12.46 | 614 | <0.05 | <0.05 |
| 24 | 12.33 | 569 | <0.05 | <0.05 |
| 24 | 12.31 | 536 | <0.05 | <0.05 |
| 26 | 12.43 | 525 | <0.05 | <0.05 |
| 29 | 12.32 | 447 | <0.05 | <0.05 |
| 30 | 12.37 | 588 | <0.05 | <0.05 |
| 32 | 12.30 | 664 | <0.05 | <0.05 |
| 33 | 12.26 | 728 | <0.05 | <0.05 |
| 36 | 12.35 | 672 | <0.05 | <0.05 |
| 39 | 12.23 | 595 | <0.05 | <0.05 |
| 41 | 12.23 | 715 | <0.05 | <0.05 |
| 52 | 12.20 | 582 | <0.05 | <0.05 |
| 53 | 12.27 | 787 | <0.05 | <0.05 |
| 54 | 12.31 | 761 | <0.05 | <0.05 |
| 55 | 12.38 | 731 | <0.05 | <0.05 |
| 59 | 12.41 | 906 | <0.05 | <0.05 |
| 60 | 12.29 | 687 | <0.05 | <0.05 |
| 61 | 12.28 | 770 | <0.05 | <0.05 |
| 62 | 12.26 | 799 | <0.05 | <0.05 |
| 70 | 12.29 | 633 | <0.05 | <0.05 |
| 75 | 12.64 | 679 | <0.05 | <0.05 |
| 77 | 12.59 | 611 | <0.05 | <0.05 |
| 81 | 12.36 | 711 | <0.05 | <0.05 |
| 85 | 12.36 | 645 | <0.05 | <0.05 |
| 88 | 12.18 | 603 | <0.05 | <0.05 |
| 93 | 12.18 | 566 | <0.05 | <0.05 |
| 102 | 12.19 | 621 | <0.05 | <0.05 |

The data shown in Table 1 indicate that small masses of slag are capable of producing elevated pH and dissolved calcium for long durations based on relatively short contact times.

### Example 2

A column containing SSF was prepared, primed, and operated according to the procedure of Example 1, except employing a shorter column SSF height of 15.2 cm (6 in.). Using the procedure of Example 1, retention time for the column was determined to be 1.6 hours.

An acidic soil sample from an old lead battery manufacturing site was provided for the test. The moisture content of the acidic soil was determined at 18%. The soil pH of the acidic soil was determined by mixing 50 g of the soil sample with DI water to achieve a liquid to solid ratio (L:S) of 1. The column was primed using the procedure of Example 1. After priming, eluate was allowed to drip into the acidic soil in 50 mL increments; pH was recorded while continuously mixing the suspension. The eluate was continuously added until the soil pH≥12. Then the soil suspension was allowed to mix for the next 72 hours to observe potential pH rebounding. Results are shown in Table 2.

TABLE 2
pH of acidic soil as a function of volume of slag column eluate added.

| Total Volume | |
|---|---|
| Eluate (mL) | pH |
| 0 | 3.71 |
| 50 | 9.22 |
| 100 | 11.48 |
| 150 | 11.58 |
| 200 | 11.65 |
| 250 | 12.20 |

### Example 3

Another sample of SSF media was combined with tap water (liquid) in 1-liter polyethylene bottles at a liquid-to-solid ratio (L/S) of 10 mL/g to provide less than about 2 mL headspace in each bottle. The bottles were sealed and tumbled at 30 revolutions per minute (RPM) for 3 hours. The resulting liquids were isolated and passed through paper coffee filters, nominally removing excess solids greater than 20 micrometers (μm) and the liquids were combined to form an SSF eluate.

Four phosphate solutions were prepared by dissolving disodium phosphate tetrahydrate (Na₂HPO₄.4H₂O) at 5, 10, 50 and 100 mg/L PO₄ in tap water at about 20° C. Aliquots of the SSF eluate were mixed with phosphate solutions in individual 125 mL polyethylene bottles, ensuring that any particulates remaining in the SSF eluate were suspended before addition to the bottles. Volumetric addition ratios of the SSF eluate were 2, 5, 10, 20 or 30% to each phosphate solution. The total volume in each bottle was adjusted to provide less than about 2 mL headspace in each bottle. Each phosphate solution without SSF was also added to a 125 mL bottle as a “control.”

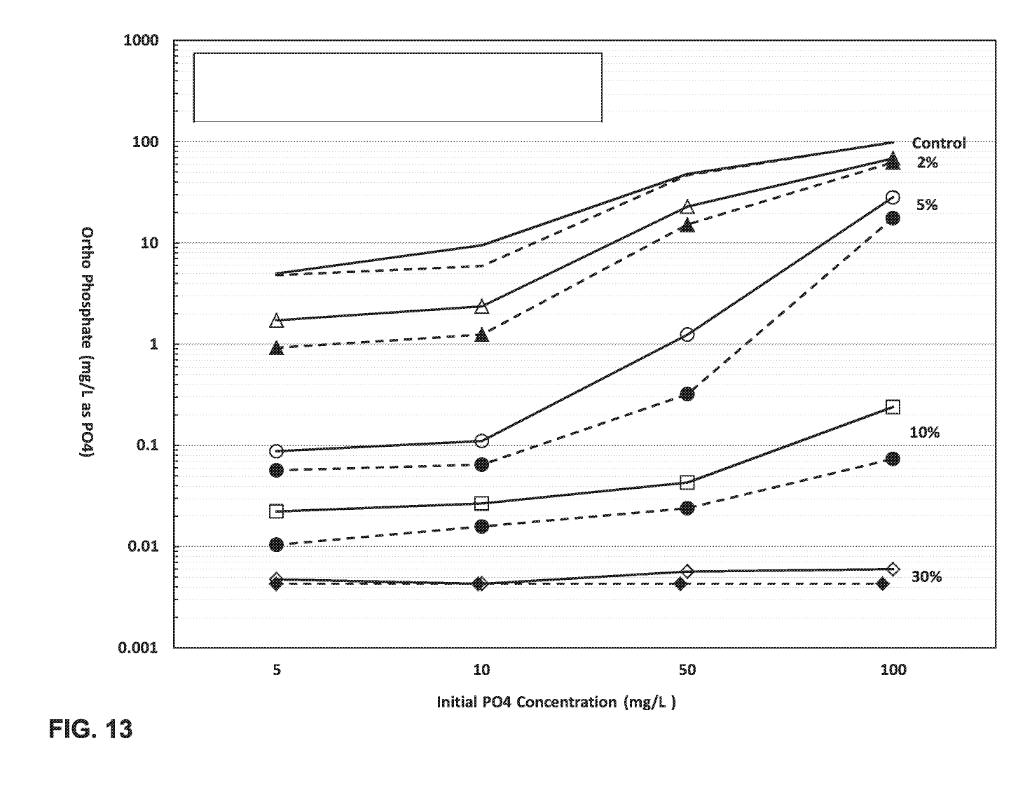

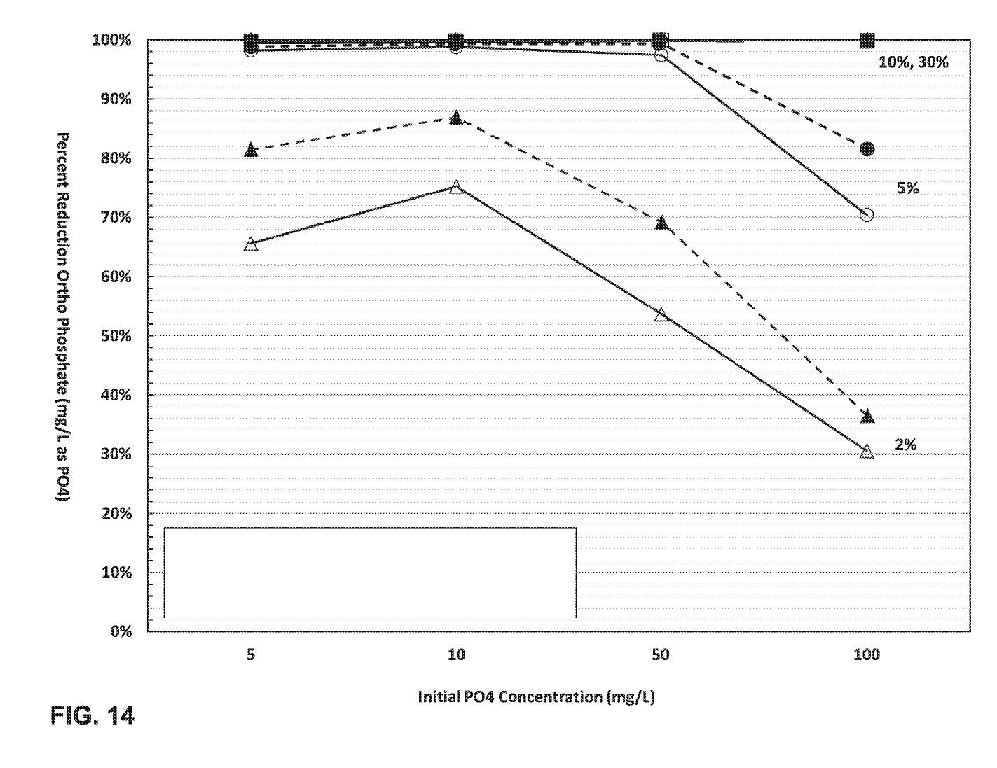

The 125 mL bottles containing the control solution and the combined SSF eluate and phosphate solutions were sealed and tumbled at 30 RPM for 18 hours. After tumbling, the contents of the bottles were filtered through 0.45-μm STERIVEX® syringe filters (obtained from Merck KgaA of Darmstadt, Germany) and analyzed for dissolved orthophosphate using a SMARTCHEM® 200 discrete chemistry analyzer (obtained from Unity Scientific of Brookfield, Conn.). Results are shown in FIGS. 13 and 14; all results were based on duplicate testing.

The process above was repeated except that the SSF (obtained in Example 1) was further sieved over a No. 8 sieve (2.36 mm) prior to combining with tap water to form an eluate thereof. The sieved SSF is designated as SSC. Results of combining the SSC eluate with phosphate using the process described above are shown in FIGS. 13 and 14.

FIG. 13 shows dissolved PO₄ concentration as a function of initial PO₄ concentration, volumetric mixing ratio (2% to 30% slag eluate addition rates) and eluate type (SSF or SSC) where open symbols denote SSC and closed symbols denote SSF and % denotes SSF or SSC eluate volumetric mixing ratio.

FIG. 14 shows the same data corrected for PO₄ dilution rate associated with the addition of the SSF or SSC eluate.

FIGS. 13 and 14 show that at less than 10 mg/L initial phosphate concentration, SSF/SSC eluate mixing ratios of 2% and 5% were effective to reduce dissolved PO₄ concentrations by nearly an order of magnitude. FIGS. 13 and 14 further show that as little as 10% SSF or SSC extract was effective to remove 50 to 100 mg/L dissolved PO₄.

### Example 4

Titrations were conducted to determine the volume of SSF eluate required to increase the pH of nitric acid (15.8 N, pH −0.85). The SSF eluate was collected in batch mode by mixing 25 g freshly crushed steel slag fines (SSF; 9.5 mm (⅜ in.) maximum) with 500 mL deionized water for 48 hrs, similar to the Generalized Acid Neutralization Capacity (GANC) procedure (Isenberg and Moore, 1992). After 48 hrs mixing, the water was filtered using a 0.45 μm Millipore nylon filter. The pH values were measured using an Accumet AR-20 pH meter.

The volume of SSF eluate required to increase the pH of 2 mL of the nitric acid to pH of ≥7 was determined to be 539 mL and 567 mL in two separate measurements. Thus, approximately 3 meq of [H⁺] reduced the pH of 100 mL of the water contacted with the SSF to about 7. The alkalinity of 100 mL water contacted with the SSF was determined to be equivalent to about 33.2 mmol NaOH.

### Example 5

A column containing SSF was prepared, primed, and operated according to the procedure of Example 2. The initial pH of an acid tar solution sample from an acid tar pit was measured as-is without any preparation. Then 10 mL of acid tar was added to an open beaker. SSF eluate (after priming) was allowed to drip directly into the beaker while the contents of the beaker were continuously mixed and pH monitored. The experiment was continued until the pH exceeded 12. During the eluate addition, a white precipitate was observed to form in the beaker. While not wishing to be limited by theory, we believe the precipitate included or was CaSO₄ formed by contact of the eluate with sulfuric acid present in the acid tar. Results of pH as a function of total eluate volume added to the beaker are shown in Table 3.

TABLE 3
pH of acid tar as a function of volume of eluate added.

| Total Volume | |
|---|---|
| Eluate (mL) | pH |
| 0 | 0.93 |
| 50 | 8.70 |
| 67.5 | 9.24 |
| 76.5 | 9.42 |
| 90 | 9.57 |
| 200 | 10.55 |

### Example 6

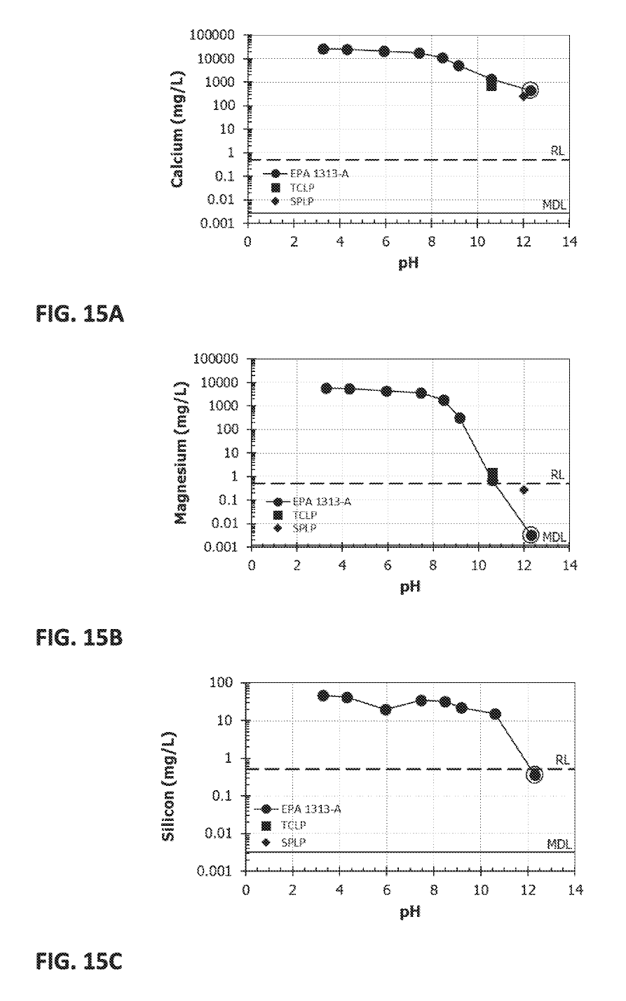

A fresh sample of stainless steel slag having a maximum particle size of 10 mm (0.375 inches) was subject to testing by USEPA Method 1313. The results are shown in FIG. 15 for Ca (FIG. 15A), Mg (FIG. 15B), and Si (FIG. 15C). Such species are indicative of the general leaching or elution properties of steel slags with varying pH. The analysis is indicative of solutes that can be delivered to one or more living plants, for example by various means of irrigation as will be familiar to one of skill; delivered to one or more impacted groundwaters or other water sources in need of treatment; or employed as a reagent solution or catalyst solution. The analytical reporting limit (RL) and method detection limit (MDL) are shown for perspective along with the toxicity characteristic leaching procedure (TCLP; EPA Method 1311) and synthetic precipitation leaching procedure (SPLP; EPA Method 1312) results that simulate environmental exposure conditions using various acids at a liquid:solid ratio of 20:1.

Using a liquid:solid ratio of 10:1, EPA 1313 directs titration of the steel slag first with deionized water (pH ˜7) to determine leaching behavior of the slag employing neutral eluant (depicted as the open circles shown in FIG. 15) and then continues the titration with increasing amounts of nitric acid, thereby simulating various environmental exposure conditions of pH from neutral to approximately 2. FIG. 15 shows that as alkalinity is removed (progressing from right to left on the plots shown for FIGS. 15A, 15B, 15C) increasing concentrations of Ca, Mg and Si are eluted down to pH=7 (e.g. tap water) at which point the steel slag would be considered as spent or exhausted and changed out.

The invention illustratively disclosed herein can be suitably practiced in the absence of any element which is not specifically disclosed herein. Additionally each and every embodiment of the invention, as described herein, is intended to be used either alone or in combination with any other embodiment described herein as well as modifications, equivalents, and alternatives thereof. In various embodiments, the invention suitably comprises, consists essentially of, or consists of the elements described herein and claimed according to the claims. It will be recognized that various modifications and changes may be made without following the example embodiments and applications illustrated and described herein, and without departing from the scope of the claims.

### First Embodiments

A first embodiment herein is an elution system including:

a support, and

an elution device mounted to the support such that the device is situated substantially above ground level, the elution device defining an inlet, an outlet, and an interior volume, the interior volume including steel slag, wherein an eluant applied to the inlet flows into the interior volume and toward the outlet, wherein said flow causes contact of the eluant with the slag.

The following additional first embodiments include features intended to be combined individually or in any combination with the first embodiment, such that additional first embodiments comprise, consist essentially thereof, or consist thereof as intended first embodiments:
a. the support is a building;
b. the elution device is mobile;
c. the elution system is mobile;
d. the eluant is substantially free of compounds or ions that react with components of the steel slag;
e. the slag is characterized as having an average particle size of about 100 μm to 15 cm;
f. the elution device is substantially filled with slag;
g. the elution system includes one or more filtration means situated proximal to the inlet, the outlet, or both;
h. the elution system includes an eluant conduit in fluid communication with the inlet;
i. the inlet of h. is in fluid communication with a rain gutter, a rooftop drain, a source of tap water, a source of surface water, a source of pressure, or a combination of two or more thereof;
j. the elution system includes an eluate conduit in fluid communication with the outlet;
k. the elution device includes a plurality of inlets, a plurality of outlets, or a plurality of both inlets and outlets;
l. the elution system includes means to distribute an eluate to a plurality of living plants;
m. the elution system includes one or more additional elution system features substantially as described elsewhere herein.

### Second Embodiments

A second embodiment herein is a method for treating a distressed water source including the following:

operably mounting an elution device to a support, the elution device defining an inlet, an outlet, and an interior volume, the interior volume comprising steel slag,

applying an eluant to the inlet, wherein the applied eluant flows into the interior volume and into contact with the slag for a period of time sufficient to form an eluate; and

dispensing the eluate from the outlet proximal to a distressed water source, wherein contact of the eluate with the distressed water source causes formation of a treated water source.

The following additional second embodiments include features intended to be combined individually or in any combination with the second embodiment, such that additional second embodiments comprise, consist essentially thereof, or consist thereof as intended second embodiments:
a. the mounting is removably mounting;
b. the method further includes one or more of the following: dissassembling the elution system; disassembling the elution device; transporting the elution device; reassembling the elution system; reassembling the elution device; carrying out one or more disassembly/reassembly cycles of the elution device; and carrying out one or more disassembly/reassembly cycles of the elution system;
c. the eluant has a first pH and the eluate has a second pH, wherein the first pH is about −1 to 8 and the second pH is about 9 to 13;
d. the eluant includes one or more of distilled water, deionized water, rain water, tap water, process water, a treated water source, surface water, or groundwater;
e. the period of time is about 10 seconds to 10 days;
f. the eluate includes about 1 mM to 1000 mM calcium hydroxide;
g. the distressed water includes a phosphate compound;
h. the contact causes one or more phosphate compounds to form a precipitate comprising calcium and phosphorus.

### Third, Fourth, and Fifth Embodiments

Third embodiments herein include the use of an elution system of any of the first embodiments described above to treat a distressed water source according to any of second embodiments described above. Fourth embodiments herein include the use of an elution system of any of the first embodiments described above to fertilize a plant. Fifth embodiments herein include the use of an elution system of any of the first embodiments described above to generate a reagent or catalyst solution.

1. An elution system comprising
a support, and
an elution device mounted to the support such that the device is situated substantially above ground level, the elution device defining an inlet, an outlet, and an interior volume, the interior volume comprising steel slag, wherein an eluant applied to the inlet flows into the interior volume and toward the outlet, wherein said flow causes contact of the eluant with the slag.

2. The elution system of claim 1 wherein the support is a building.

3. The elution system of claim 2 wherein the inlet is in fluid communication with a rain gutter, a rooftop drain, a source of tap water, a source of surface water, a source of pressure, or a combination of two or more thereof.

4. The elution system of claim 1 wherein the elution device or the elution system is mobile.

5. The elution system of claim 1 wherein the eluant is substantially free of compounds or ions that react with components of the steel slag.

6. The elution system of claim 1 wherein the slag is characterized as having an average particle size of about 100 μm to 15 cm as determined by sieving.

7. The elution system of claim 1 wherein the elution device is substantially filled with slag.

8. The elution system of claim 1 further comprising one or more filtration means situated proximal to the inlet, the outlet, or both.

9. The elution system of claim 1 further comprising an eluant conduit in fluid communication with the inlet, an eluate conduit in fluid communication with the outlet, or both.

10. (canceled)

11. The elution system of claim 1 wherein the device comprises two or more inlets, two or more outlets, or both.

12. The elution system of claim 1 further comprising means to distribute an eluate to a plurality of living plants.

13. A method for treating a distressed water source, the method comprising
operably mounting an elution device to a support, the elution device defining an inlet, an outlet, and an interior volume, the interior volume comprising steel slag,
applying an eluant to the inlet, wherein the applied eluant flows into the interior volume and into contact with the slag for a period of time sufficient to form an eluate; and
dispensing the eluate from the outlet proximal to a distressed water source, wherein contact of the eluate with the distressed water source causes formation of a treated water source.

14. The method of claim 13 wherein the mounting is removably mounting.

15. The method of claim 13 further comprising one or more of the following: dissassembling the elution system; disassembling the elution device;
transporting the elution device; reassembling the elution system; reassembling the elution device; carrying out one or more disassembly/reassembly cycles of the elution device; and
carrying out one or more disassembly/reassembly cycles of the elution system.

16. The method of claim 13 wherein the eluant has a first pH and the eluate has a second pH, wherein the first pH is about −1 to 8 and the second pH is about 9 to 13.

17. The method of claim 13 wherein the eluant comprises one or more of distilled water, deionized water, rain water, tap water, process water, a treated water source, surface water, or groundwater.

18. The method of claim 13 wherein the period of time is about 10 seconds to 10 days.

19. The method of claim 13 wherein the eluate comprises about 1 mM to 1000 mM calcium hydroxide.

20. The method of claim 13 wherein the distressed water comprises a phosphate compound.

21. The method of claim 13 wherein the contact causes one or more phosphate compounds to form a precipitate comprising calcium and phosphorus.
